(19) United States
(12) Patent Application Publication
(10) Pub. No.: US 2012/0060622 A1
(43) Pub. Date: Mar. 15, 2012

(54) SYSTEMS AND METHODS FOR SIMULATING FLOW OF CEREBROSPINAL FLUID

(76) Inventors: CAROLYN ANNE HARRIS, Bellevue, WA (US); James Patterson McAllister, Overland Park, KS (US)

(21) Appl. No.: 13/229,138

(22) Filed: Sep. 9, 2011

Related U.S. Application Data
(60) Provisional application No. 61/381,773, filed on Sep. 10, 2010.
(60) Provisional application No. 61/516,661, filed on Apr. 6, 2011.

(51) Int. Cl. G01F 1/00; F15D 1/00

(52) U.S. Cl. 73/861; 137/565.01

(57) ABSTRACT

Systems and methods for controlling and monitoring flow of a desired fluid are disclosed. An in vitro pulsatile flow system has a fluid reservoir that contains the desired fluid, which simulates a physiologic fluid, such as cerebrospinal fluid. A pump transports the desired fluid from the fluid reservoir to a test material to permit monitoring of adhesion of cells and tissue to the test material.

### CROSS-REFERENCE TO RELATED APPLICATION

This application claims priority to U.S. Provisional Patent Application No. 61/381,773, which was filed on Sep. 10, 2010, and to U.S. Provisional Patent Application No. 61/516,661, which was filed on Apr. 6, 2011, both of which are hereby incorporated by reference in their entirety.

### BACKGROUND OF THE INVENTION

1. Field of the Invention

This invention relates to systems and methods for simulating flow of cerebrospinal fluid, and, more particularly, to systems and methods for testing the performance of medical implants and compounds during simulated circulation of cerebrospinal fluid.

2. Description of the Prior Art

Hydrocephalus, an imbalance between cerebrospinal fluid (CSF) production and absorption, is a chronic disorder that afflicts 1 in 500 people, mainly young children and older adults, with up to 78% suffering long-term neurological deficits. Surgical drainage of CSF is the only treatment for hydrocephalus. In most cases, the patient becomes dependent on a shunt system comprised of two polydimethylsiloxane (PDMS, silicone) catheters joined in series by a pressure valve to drain excess CSF from the cerebral ventricles. The main impediment facing hydrocephalus treatment is the high rate of shunt failure—43% of the $2 billion in annual direct costs to treat hydrocephalus is consumed by revisions to failed shunts. The failure rate for shunts is one of the highest of all neurosurgical procedures. In addition, the related costs to society can be measured by lives lost following shunt failure, morbidity, and especially a lower quality of life for patients and their families. The consensus among neurosurgeons is that shunt malfunctions are one of the major causes of persistent neurological deficits. Over 60 years of shunt development have yielded improvements in flow control valves, but tragically, there has been a lack of advancements that reduce shunt failure due to catheter obstruction. Consequently, shunt failure remains a serious problem, primarily because of tissue obstruction, and especially with the ventricular catheter. Many studies have reported that approximately 60% of shunt complications are caused by obstruction.

A major obstacle to reducing shunt obstruction is that known in vitro systems do not incorporate pertinent physiological parameters. Rather, they typically consist of static environments that lack the dynamics of CSF flow, pressure, pulsatility, and protein concentration. In vitro flow systems used to study shear stress effects on cells do not mimic the appropriate flow vector fields seen within a catheter under intracranial conditions. Furthermore, known in vitro systems do not utilize whole tissues, such as the choroid plexus, which are known to infiltrate the input holes of ventricular catheters. These technical barriers impede understanding of reasons for catheter blockage and slow development of new strategies to inhibit obstruction.

Obstruction of ventricular catheters is multi-faceted, but post-hoc analyses strongly suggest that the two most predominant causes stem from infiltration by inflammatory cells and choroid plexus tissue. Cytological analysis of ventricular catheter explants has revealed layers of microglia/macrophages and astrocytes surrounding catheters, infiltrating the flow input holes and clogging the lumen.

Both the injury response to ventriculomegaly and the insertion of the CSF-drainage catheter through the cerebral cortex into the ventricle cause activation of macrophages (microglia) and astrocytes that are known to adhere to and encapsulate shunt catheters. Secondary injury mechanisms associated with hydrocephalus, including tissue stretch and compression, cerebral ischemia and hypoxia, edema, cell death, and the buildup of toxins all lead to hypertrophy and proliferation of microglia and astrocytes (glia) soon after ventricular expansion. Glial activation accelerates pro-inflammatory cytokine responses and releases further neurotoxic mediators. Generally, inflammatory reactions caused by hydrocephalus occur in the periventricular white matter but can also be found throughout the cortical gray matter, both regions through which the ventricular catheter must pass. In addition, the foreign body reaction produces a local inflammatory response around the implant. At the CSF-shunt catheter interface, opsonization, the process by which the material is covered by any available molecule that might enhance phagocytosis, occurs. In response to the surface properties of the catheter, opsonins, such as CSF and tissue fluid proteins, complement the catheter, and antigens adsorb to the catheter within seconds of implantation. Opsoninization results in surface bound ligands that can provide sites for specific inflammatory cell and antibody attachment. Individual monocytes, microglia, and macrophages bind to the surface in an effort to phagocytose the catheter and by this reaction alone, genes encoding inflammatory mediators are enhanced. This process continues for the life of the implant, and with time astrocytic end feet and collagen can form a sheath around the catheter. Thus, modulation of inflammatory cell adhesion to the silicone catheter is crucial to long term patency.

Choroid plexus infiltration is often indentified by neurosurgeons as the most troublesome problem in the treatment of hydrocephalus. Most catheters are positioned in the frontal horn of the lateral ventricle because these chambers are the largest CSF spaces which can be drained efficiently and safely. However, the ventricles also contain the CSF-producing choroid plexus tissue, which protrudes from the floor of the lateral ventricles and with adequate force can be pulled into the holes of the catheter causing obstruction. The obstruction mechanisms of the choroid plexus are distinguishable from cell-derived obstruction in that the choroid plexus invades the catheter holes and lumen as a whole tissue rather than as individual cells. Known models of individual choroid plexus epithelial cell attachment have inhibited progress in understanding choroid plexus attachment mechanisms. Not only have these known models inappropriately mimicked tissue invasion, but they also cannot measure infiltration under physiologically relevant conditions, such as CSF flow, pressure, and pulsation frequency that are known to impact cell adhesion. Moreover, known models are incapable of simulating mechanical contact between the ventricular wall and the catheter, which can instigate tissue infiltration through adhesion of supraependymal macrophages.

Perhaps because the treatment of hydrocephalus has conventionally (and naively) been considered to be a “plumbing problem” in which attempts are made to simply restore CSF bulk flow and absorption, studies of the causes of catheter obstruction have not focused on cellular or biomechanical adherence mechanisms. Surprisingly, the FDA does not require intracranial or intraventricular testing of shunt systems, and thus most of the time catheter designs are simply tested by implantation into subcutaneous sites with no fluidic dynamics.

While in vivo intracranial approaches of course provide a good physiological environment for testing new catheter designs, these test sites can be complicated by the extremely variable pathophysiologic progression of hydrocephalus. These mechanisms cannot be controlled easily and thus in vivo approaches can be inefficient, at least in early stages of design and testing.

Accordingly, there is a need in the pertinent art for systems and methods for evaluating infiltration and obstruction of medical implants under flow, pressure, and pulsatility parameters that correspond to the physiological ranges seen in hydrocephalus, thereby providing an in vitro environment in which both hydrodynamic parameters (flow rate, pressure, pulsatility) and different components of obstruction (individual cells as well as whole tissues) can be evaluated prior to in vivo analysis. There is a further need in the pertinent art for systems and methods for evaluating infiltration and obstruction of medical implants that permit immersion of the medical implant in a simulated CSF bath that has a similar viscosity and protein concentration to CSF, thereby producing clinically applicable flow vector fields, flow rates, and shear stresses through the holes and within the lumen of the medical implant.

### SUMMARY OF THE INVENTION

Described herein are systems and methods for controlling and monitoring flow of a desired fluid. In exemplary aspects, the desired fluid simulates a physiologic fluid, such as a cerebrospinal fluid. In one aspect, an in vitro pulsatile flow system is used to control the flow of the desired fluid. In exemplary applications, the in vitro pulsatile flow system is used to monitor adhesion of at least one component of the desired fluid to a test material, such as a medical implant. The in vitro pulsatile flow system has a fluid reservoir that contains the desired fluid. The test material of the system is positioned in fluid communication with the desired fluid such that the desired fluid contacts at least a portion of the test material. In an additional aspect, the flow system includes a pump positioned between and in fluid communication with the fluid reservoir and the test material. In some aspects, when the test material is a medical implant having a bore, the pump is placed in direct fluid communication with the bore of the medical implant. In other aspects, the test material is placed within a housing that is placed in fluid communication with the pump. In a further aspect, the flow system has a pressure valve positioned between and in fluid communication with the test material and the fluid reservoir. Methods of using the flow system to screen compounds and test materials for inhibition of cell adhesion are also disclosed.

### BRIEF DESCRIPTION OF THE DRAWINGS

These and other features of the preferred embodiments of the invention will become more apparent in the detailed description in which reference is made to the appended drawings wherein:

FIG. 1A shows a diagram of an exemplary in vitro pulsatile flow system, as described herein. FIG. 1B depicts an exemplary medical implant test material for use with the flow system of FIG. 1A, as described herein. FIG. 1D shows a diagram of a second exemplary pulsatile flow system, as described herein. FIG. 1D depicts an exemplary medical implant test material for use with the flow system of FIG. 1C, as described herein.

FIG. 2 shows confocal images of cell attachment to horizontally fixed catheters (A-C) and to vertically fixed catheters (D-E) at varying flow rates. FIG. 2 also shows the graphical orientation of the images.

FIG. 3A shows the mean percent of catheter area occupied by astrocytic nuclei for both horizontally fixed catheters and vertically fixed catheters under varying flow rates. FIG. 3B shows the mean percent concentrated cell debris for both horizontally fixed catheters and vertically fixed catheters under varying flow rates.

FIG. 4 shows confocal images of cell attachment to horizontally fixed catheters (A-B) and to vertically fixed catheters (C-D) at average luminal pressures of −1.66 mm Hg (A and C) and 16.43 mm Hg (B and D).

FIG. 5A shows the mean percent of catheter area occupied by astrocytic nuclei for both horizontally fixed catheters and vertically fixed catheters at varying pressures. FIG. 5B shows the mean percent concentrated cell debris for both horizontally fixed catheters and vertically fixed catheters at varying pressures.

FIG. 6 shows confocal images of cell attachment to horizontally fixed catheters (A-C) and to vertically fixed catheters (D-F) at the following pulsation rates: 70 pulses/min (A and D), 100 pulses/min (B and E), and 200 pulses/min (C and F).

FIG. 7A shows the mean percent of catheter area occupied by astrocytic nuclei for both horizontally fixed catheters and vertically fixed catheters at varying pulsatility. FIG. 7B shows the mean percent concentrated cell debris for both horizontally fixed catheters and vertically fixed catheters at varying pulsatility.

FIG. 8 shows an exemplary in vitro pulsatile flow system, as described herein.

FIG. 9 shows the effect of CSF flow rate on inflammatory cell binding to catheter tubing.

FIG. 10 shows the effect of pressure on inflammatory cell binding to catheter tubing.

FIG. 11 shows the effect of CSF pulsatility on inflammatory cell binding to catheter tubing.

FIG. 12 shows confocal images of cell attachment to horizontally fixed catheters (left panels) and vertically fixed catheters (right panels) on bare silicone surfaces (top panels) and hydrophilic silicone surfaces (bottom panels).

FIG. 13 shows a schematic depiction of an exemplary in vitro pulsatile flow system, as described herein.

FIG. 14 shows scanning electron microscopy images of 500-μm diameter hole samples, as described herein in Example 2.

FIG. 15 displays the total nuclei area measured for samples corresponding to various fabrication methods, as described herein in Example 2.

FIG. 16 displays (a) macrophage and (b) astrocyte DAPI intensities around the holes of various samples, as described herein in Example 2.

FIG. 17 displays Gross (a, d, g, j, m) and scanning electron (b, c, e, f, h, i, k, l, n, o) microscopy images depicting the total hole surface area and the surface morphology of groups 1 and 2, as described in Example 2. The distance between holes was fixed at 500 μm from the most exterior hole edge (489.6±92.4 μm). The scale bar in (n) represents 1,000 μm at ×40 (b, e, h, k, n); the scale bar in (o) represents 100 μm at ×400 (c, f, i, l, o)

FIG. 18 displays adhesion of macrophages (a-d) and astrocytes (e-h) as a function of hole size, as described herein in Example 2. DAPI was used to label the nuclei. The scale bar denotes 500 μm

FIG. 19 displays the area occupied by cells around all holes of the various samples, as described herein in Example 2.

FIG. 20 displays (a) macrophage and (b) astrocyte adhesion as a function of hole diameter in a catheter and the orientation in which the catheter was positioned within a flow system as described herein.

FIG. 21 displays (a) macrophage and (b) astrocyte adhesion as a function of proximity to a catheter tip. The position relative to the catheter tip is expressed as a percentage, where 0% represents adhesion closest to the tip and 100% denotes adhesion farthest from the tip.

FIG. 22 displays (A) representative illustrations of adherent living macrophages stained with Iba-1, and (B) astrocytes stained positively with GFAP and Toluidine blue to confirm cell type, as discussed herein in Example 3. Scale bar denotes 20 μm.

FIG. 23 displays (A) Macrophage and (B) astrocyte counts in suspension after exposure to flow conditions with and without the use of a peristaltic pump, as discussed herein in Example 3.

FIG. 24 displays (A) Macrophage and (B) Astrocyte count in suspension after exposure to varying protein concentrations, as described herein in Example 3.

FIG. 25 displays the effect of flow system components on (A) macrophage and (B) astrocyte count in suspension, as described herein in Example 3. Here, “+” denotes that a component has been added to the preceding condition.

FIG. 26 displays (A) Macrophage and (B) astrocyte count in suspension after exposure to varying surface chemistries of transport tubing, as described herein in Example 3.

FIG. 27 displays (A) Living and (B) dead macrophage and (C) living and (D) dead (D) astrocyte concentration over time, as described herein in Example 3.

FIG. 28 displays a Kruskal Wallis H Test of the degree of macrophage and astrocyte adhesion after one or three consecutive incubations, as described herein in Example 3.

FIG. 29 displays (A) Bound macrophages and (B) astrocytes on PDMS samples stained for apoptotic cells, necrotic cells, and healthy cells using aPromoKine Apoptotic/Necrotic/Healthy Cell Detection Kit, as described herein in Example 3. Images were acquired using a 10× objective. The scale bar denotes 100 μm.

FIG. 30 displays the degree of macrophage and astrocyte adhesion as determined by the average percent blue component in dRGB space (fluorescently stained nuclei), as described herein in Example 3.

### DETAILED DESCRIPTION OF THE INVENTION

The present invention may be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

All patents, patent applications and publications cited herein, whether supra or infra, are hereby incorporated by reference in their entireties into this application in order to more fully describe the state of the art as known to those skilled therein as of the date of the invention described and claimed herein.

As used in the specification and the appended claims, the singular forms “a,” “an” and “the” include plural referents unless the context clearly dictates otherwise. Thus, for example, reference to a “medical implant” can include two or more such medical implants unless the context indicates otherwise.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The word “or” as used herein means any one member of a particular list and also includes any combination of members of that list.

As used herein, the terms “optional” or “optionally” mean that the subsequently described event or circumstance may or may not occur, and that the description includes instances where said event or circumstance occurs and instances where it does not.

Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Except as specifically defined herein, all technical and scientific terms used herein are to be given as broad a commonly understood meaning as possible while maintaining claim validity.

By “sample” is meant an animal; a tissue or organ from an animal; a cell (either within a subject, taken directly from a subject, or a cell maintained in culture or from a cultured cell line); a cell lysate (or lysate fraction) or cell extract; or a solution containing one or more molecules derived from a cell or cellular material (e.g. a polypeptide or nucleic acid), which is assayed as described herein. A sample may also be any body fluid or excretion (for example, but not limited to, blood, urine, stool, saliva, tears, bile) that contains cells or cell components.

As used herein, the term “medical implant” refers to any element that is designed for insertion or positioning within an animal body for any amount of time. Thus, as used herein, a “medical implant” refers to elements that are designed for only temporary insertion within an animal body, as well as elements that are designed for permanent or indefinite insertion within an animal body. Exemplary “medical implants” include medical devices, such as ventricular catheters as further described herein.

As used herein, the term “physiologic fluid” refers to any non-simulated fluid that is obtained from an animal (e.g., a human). Thus, a “physiologic fluid” includes all fluids that naturally flow within an animal during normal functioning of the animal as well all fluids that naturally flow within the animal during abnormal or pathological functioning of the animal. For example, normal cerebrospinal fluid (CSF) as well as hydrocephalic CSF are physiologic fluids.

As used herein, a “subject” is an individual and includes, but is not limited to, a mammal (e.g., a human, horse, pig, rabbit, dog, sheep, goat, non-human primate, cow, cat, guinea pig, or rodent), a fish, a bird, a reptile or an amphibian. The term does not denote a particular age or sex. Thus, adult and newborn subjects, as well as fetuses, whether male or female, are intended to be included. A “patient” is a subject afflicted with a disease or disorder. The term “patient” includes human and veterinary subjects. As used herein, the term “subject can be used interchangeably with the term “patient.”

Disclosed herein are in vitro systems and methods for simulating flow of cerebrospinal fluid. In exemplary applications, the disclosed methods and systems can be used to simulate or model flow of cerebrospinal fluid under various conditions. However, it is contemplated that the disclosed methods and systems can be used to simulate or model flow of any desired fluid. The disclosed methods and systems can be further used for monitoring adhesion of various components of a desired fluid to a test material, such as a medical implant.

As further described herein, it is contemplated that in vivo flow parameters can have an influential role in adhesion of components of various fluids to medical implants and other materials placed within the body of an animal. Unlike known flow systems, the disclosed flow system permits variations in cell concentration, protein concentration, cell type, protein concentration, fluid viscosity, and exposure time, among other parameters, to evaluate cellular adhesion to one or more test materials under simulated in vivo conditions. The disclosed flow system also permits direct contact between a test material and selected tissue constructs to accurately simulate in vivo conditions. The disclosed flow system permits entry of various chemical factors into the desired fluid to permit evaluation of the impact the chemical factors have on cellular adhesion to a test material. Fundamentally, the disclosed flow system provides a platform for more accurately modeling cell adhesion. The disclosed system, which produces clinically applicable fluid flow rates, pressures, and pulsation frequencies that can be quantified, provides a physiologic perspective that is not possible in an in vivo animal model, where such variables are based on the animal's heart rate, choroid plexus size, level of anesthesia, and the like.

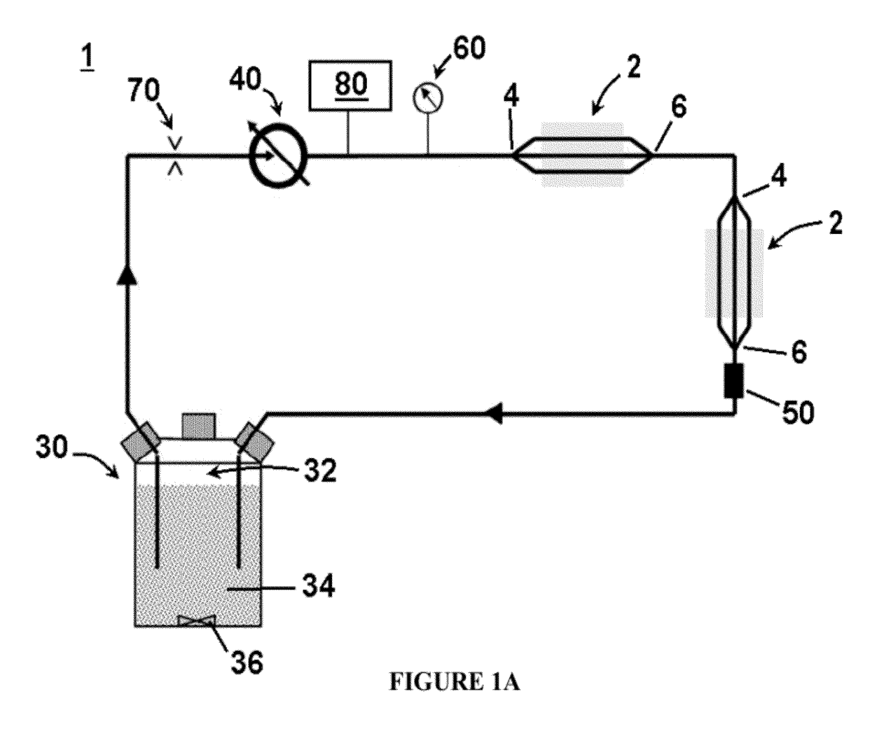

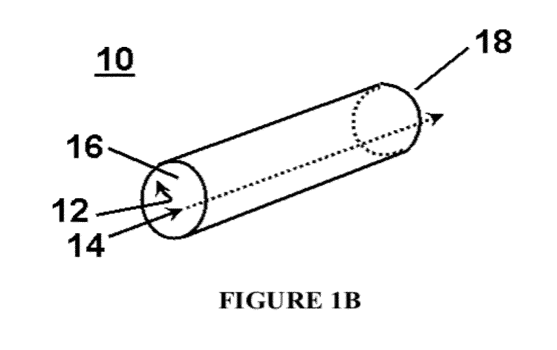

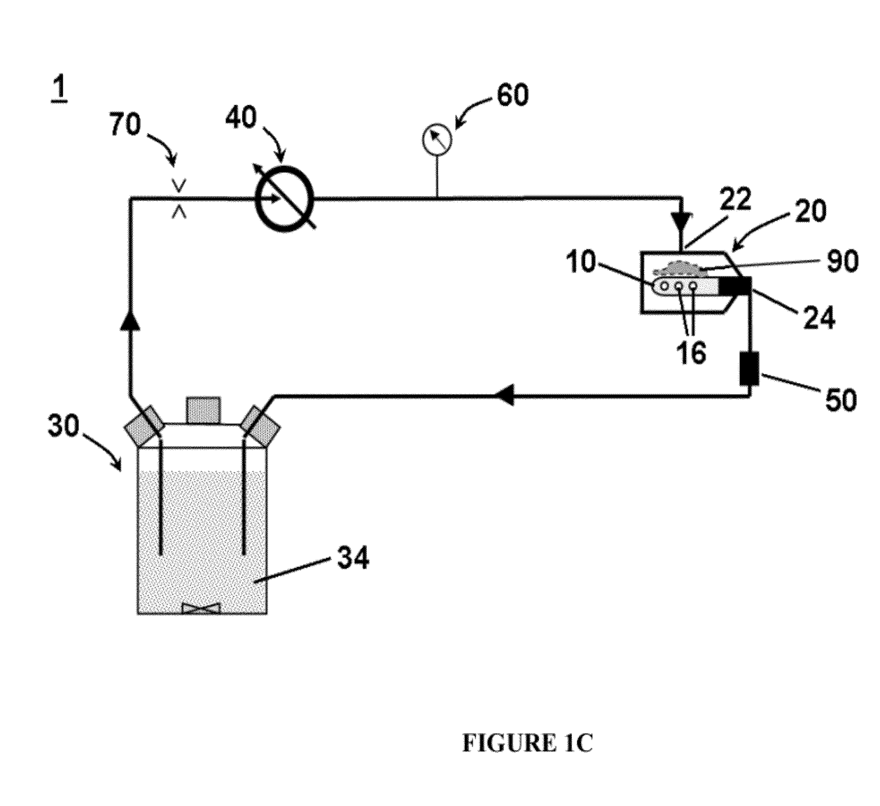

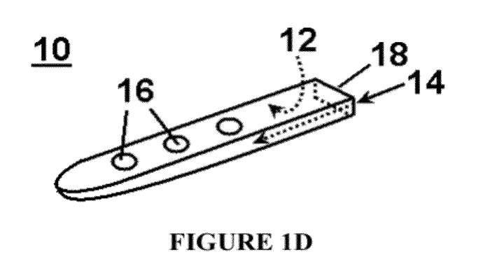

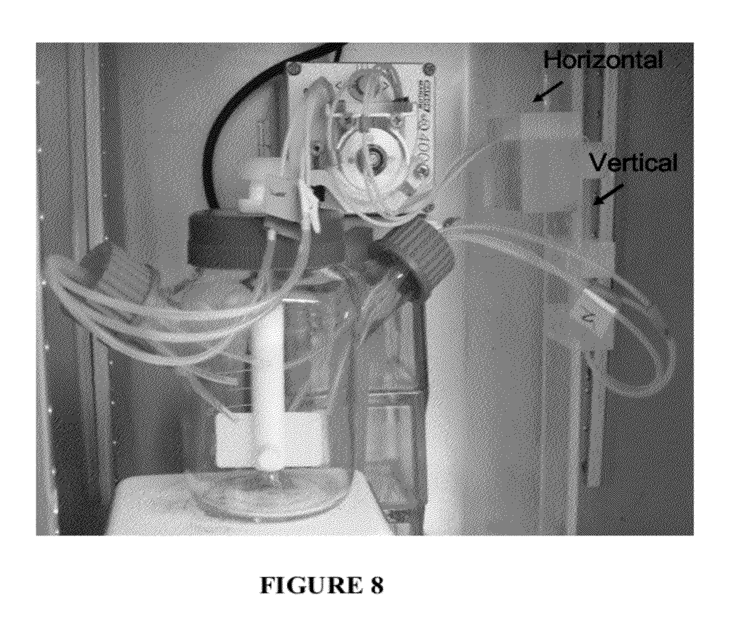

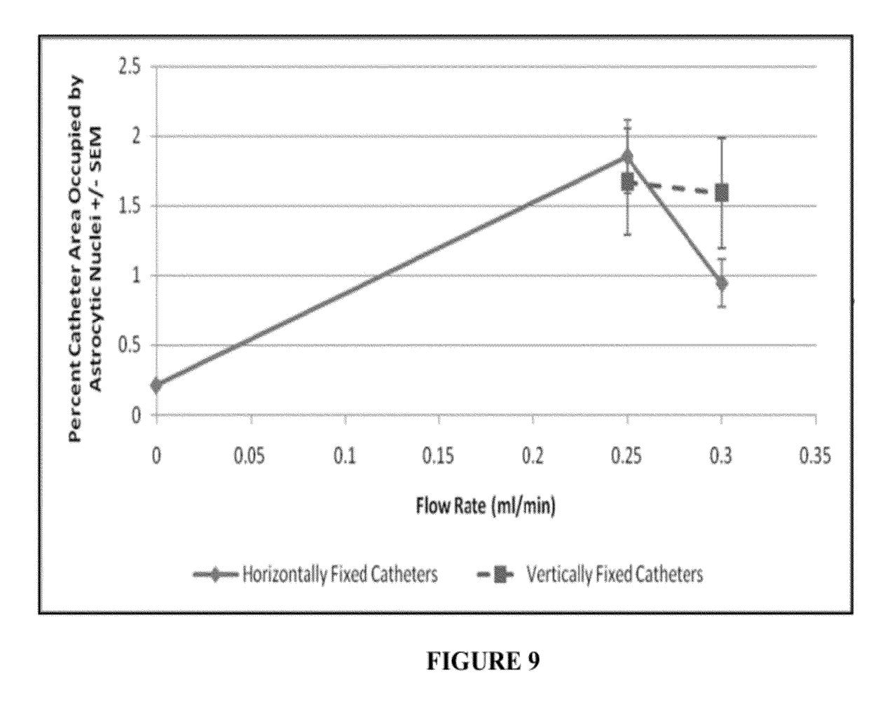

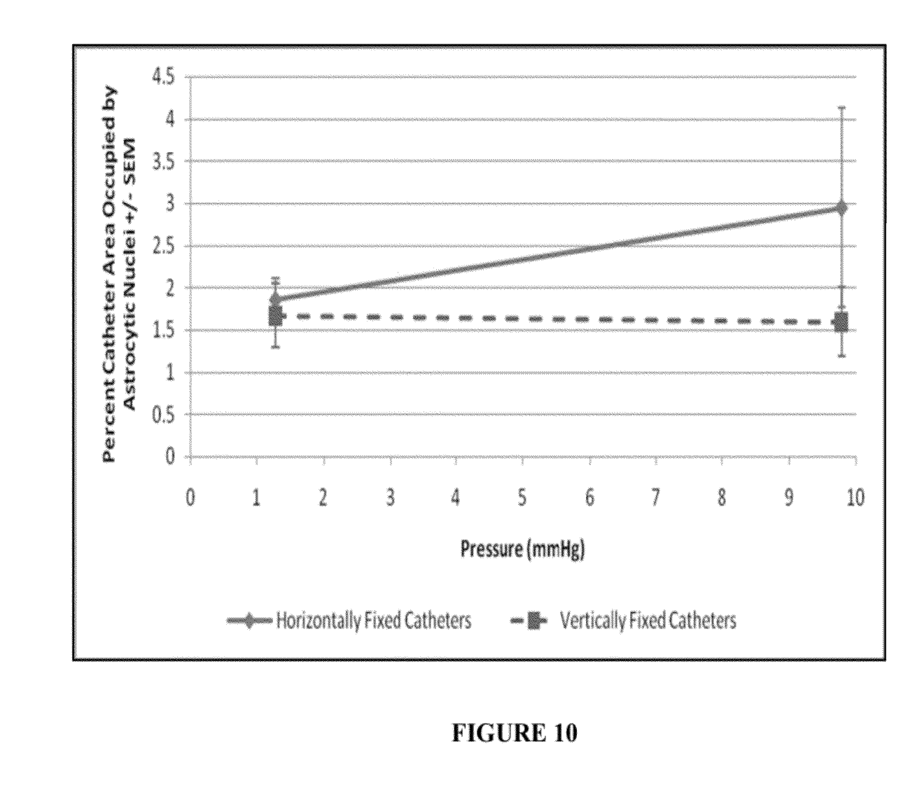

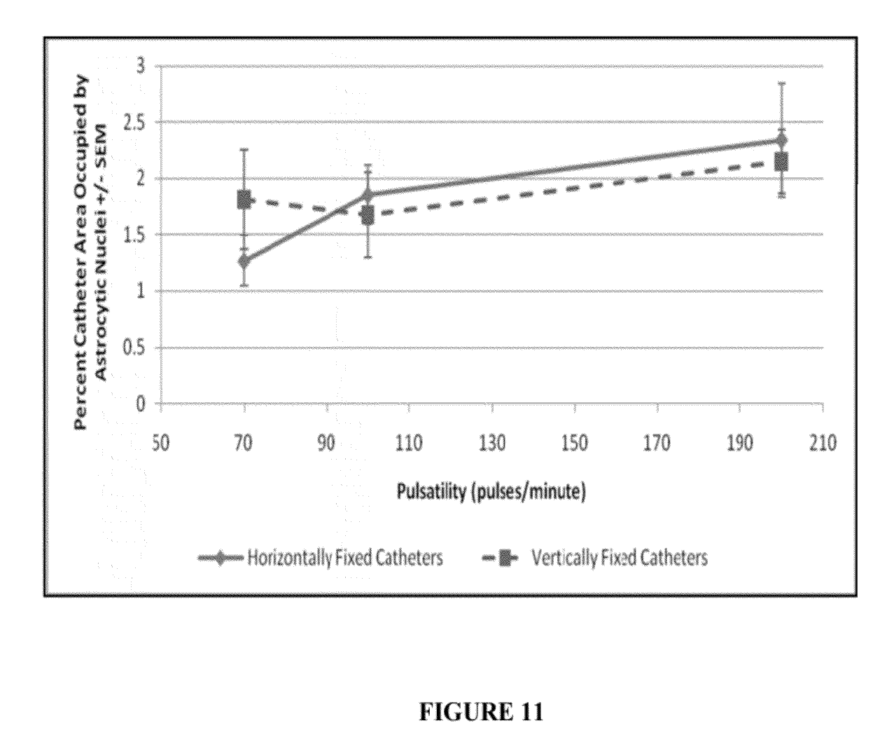

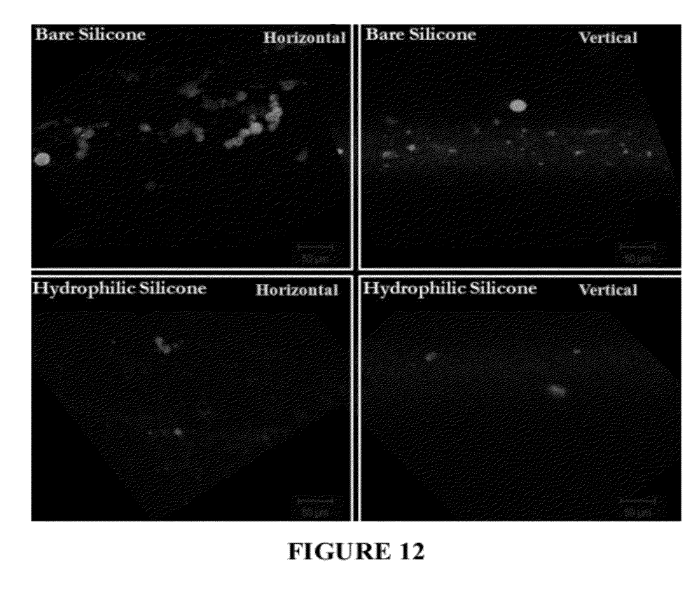

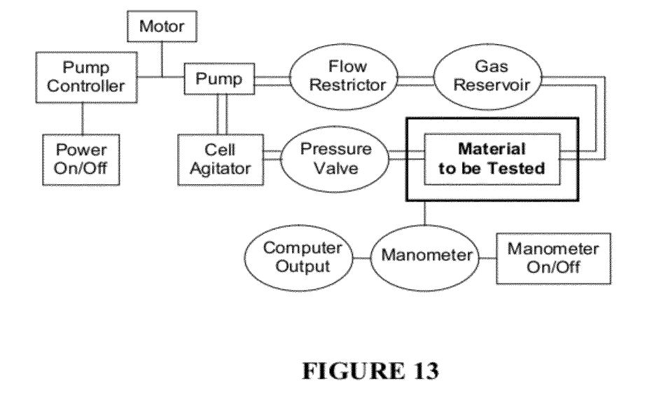

In exemplary aspects, and with reference to FIGS. 1-30, an in vitro pulsatile flow system 1 is disclosed. In one aspect, and as shown in FIGS. 1, 8, and 13, the flow system 1 can comprise a fluid reservoir 30 defining an inner chamber 32. In this aspect, the inner chamber 32 of the fluid reservoir 30 can be configured to contain a desired fluid 34. In one aspect, the desired fluid 34 can comprise a physiologic fluid, such as, for example and without limitation, cerebrospinal fluid (CSF) from a mammalian source. In this aspect, it is contemplated that the desired fluid 34 can be normal CSF, such as is present in an animal under normal conditions, or hydrocephalic CSF, such as is present in an animal under hydrocephalic conditions. In another aspect, the desired fluid 34 can be configured to simulate a physiologic fluid, such as, for example and without limitation, normal and hydrocephalic CSF.

In one aspect, it is contemplated that the desired fluid 34 can comprise at least one component. In this aspect, the at least one component of the desired fluid 34 can be one or more of cells, proteins, tissue, selected compositions, and the like. For example, in an exemplary aspect, the desired fluid 34 can comprise cells. In this aspect, the desired fluid 34 can comprise at least one of, for example and without limitation, astrocytes, macrophages, microglia, bacteria, neurons, oligodendrocytes, endothelial cells, red blood cells, platelets, cellular debris and other cells that can block or adhere to medical implants, such as catheters. In one aspect, prior to circulation of the desired fluid 34 through the in vitro pulsatile flow system 1, the concentration of cells within the desired fluid can be any desired value, including cell concentrations ranging from about 750 to about 280,000 cells per milliliter (cells/mL). In an exemplary aspect, it is contemplated that, prior to circulation of the desired fluid through the in vitro pulsatile flow system, the concentration of cells within the desired fluid can range from about 40,000 cells/mL to about 50,000 cells/mL, and, more preferably, be about 41,000 cells/mL, which approximates the concentration of inflammatory white blood cells in hydrocephalic CSF. It is contemplated that this concentration of cells within the desired fluid can correspond to approximately 3×10⁶ (3,000,000) astrocytes and/or macrophages.

In another aspect, the desired fluid 34 can comprise proteins. In this aspect, the desired fluid 34 can comprise, for example and without limitation, fetal bovine serum, bovine serum albumin, and the like. In an exemplary aspect, it is contemplated that, prior to circulation of the desired fluid 34 through the in vitro pulsatile flow system 1, the concentration of protein within the desired fluid can range from about 20 mg per deciliter (mg/dL) to about 40 mg/dL of total protein, with a concentration of albumin ranging from about 10 mg/dL to about 20 mg/dL. It is further contemplated that these exemplary concentrations can correspond to the approximate protein and albumin concentrations in CSF or another physiologic fluid.

In a further aspect, the desired fluid 34 can comprise tissue. Optionally, the tissue can be native tissue, such as, for example and without limitation, choroid plexus tissue. Alternatively, the tissue can be an in vitro tissue construce. In an exemplary aspect, the desired fluid 34 can comprise an in vitro tissue construct that is prepared by creating layers of epithelial cells and/or choroid plexus ependymal cells that are removed as entire tissues from a culture area, such as, for example and without limitation, polystyrene dishes coated with temperature-sensitive poly(N-isopropylacrylamide). In an alternative exemplary aspect, the desired fluid 34 can comprise an in vitro tissue construct that is prepared by seeding one or more layers of epithelial cells on a polymer, such as, for example and without limitation, an acrylate-based polymer with cultured cells, that mimics the thickness and mechanical integrity of the choroid plexus.

In still a further aspect, the desired fluid 34 can comprise a composition, a suspected therapeutic, or a material suspected to reduce or inhibit adhesion of at least one additional component of a desired fluid to a test material, such as a medical implant. For example, the desired fluid 34 can comprise anti-inflammatory agents, metabolic inhibitors, trophic factors, agents that reduce interstitial and cytological edema, anti-sense molecules, RNA silencing agents, and membrane transport inhibitors.

In another aspect, and with reference to FIGS. 1A and 1C, the flow system 1 can comprise an agitator 36 positioned within the inner chamber 32 of the fluid reservoir 30. In this aspect, it is contemplated that the agitator 36 can be configured to stir the desired fluid 34. It is further contemplated that the agitator 36 can be configured to stir the desired fluid 34 such that cells or other components within the desired fluid are maintained in suspension. In one aspect, the agitator 36 can be adjustably rotated at a desired speed. In this aspect, it is contemplated that the desired speed of rotation of the agitator 36 can be about one rotation per second. In another aspect, during operation, the agitator 36 can be configured to substantially continuously stir the desired fluid 34. Alternatively, during operation, the agitator 36 can be configured to reciprocally stir the desired fluid 34. In one exemplary aspect, it is contemplated that the agitator 36 can selectively stir the desired fluid 34 in both a continuous and a reciprocal manner. In a further aspect, the timing of operation of the agitator 36 can be selectively controlled. It is contemplated that the desired speed of rotation of the agitator 36, the style of stirring employed by the agitator, and the timing of operation of the agitator can be modulated to minimize undesirable adherence of the at least one component of the desired fluid 34 to the surfaces of the inner chamber 32 of the fluid reservoir 30.

In an additional aspect, and with reference to FIG. 1A, the flow system 1 can comprise a testing section 2 having an inlet 4 and an outlet 6. It is contemplated that the inlet 4 of the testing section 2 can be configured to receive the desired fluid 34. In one aspect, the testing section 2 can comprise a test material, such as, for example and without limitation, a medical implant 10. In this aspect, as shown in FIG. 1B, the medical implant 10 can have an inner surface 12 that defines a bore 14. The bore 14 of the medical implant 10 can have an inlet 16 and an outlet 18. It is contemplated that the inlet 16 of the bore 14 of the medical implant 10 can correspond to the inlet 4 of the testing section 2 and that the outlet 18 of the bore of the medical implant can correspond to the outlet 6 of the testing section.

In operation, the inlet 16 of the bore 14 of the medical implant 10 can be configured to receive the desired fluid 34, and the inner chamber 32 of the fluid reservoir 30 can be in fluid communication with the outlet 18 of the bore of the medical implant. It is contemplated that the bore 14 of the medical implant 10 can have an inner diameter ranging from about 0.5 to about 2.5 mm, and, more preferably, being about 1.5 mm. However, it is further contemplated that a bore having any inner diameter can be used with the disclosed flow system 1. As used herein, the term “medical implant” can refer to an entire medical implant as well as a selected portion of a medical implant. Although the following and foregoing description of the test material is primarily made with reference to the medical implant 10, it is understood that a medical implant is only one type of test material that can be used within the flow system 1. Thus, unless otherwise stated, statements made herein with respect to the medical implant 10 are equally applicable to any other test material.

In one aspect, the medical implant 10 can be a conventional catheter, including, for example and without limitation, a hydrocephalus shunt catheter. In another aspect, the medical implant 10 can be a conventional ventricular catheter tip. However, it is contemplated that the medical implant 10 can be any construct or device that is conventionally inserted or implanted into an animal body. In one aspect, the medical implant 10 can comprise one or more solid materials.

Alternatively, in another aspect, the testing section 2 can comprise a test material housing 20 having an inlet 22 and an outlet 24. In an exemplary aspect, the test material housing 20 can be configured to approximate the size and/or shape of a ventricle within the brain of a subject. In another exemplary aspect, the test material housing 20 can be a syringe. In this aspect, the test material housing 20 can optionally be a syringe that has had its cannula removed. It is contemplated that the inlet 22 of the test material housing 20 can correspond to the inlet 4 of the testing section 2 and that the outlet 24 of the test material housing can correspond to the outlet 6 of the testing section. In an additional aspect, the flow system 1 can comprise a test material positioned within the test material housing 20 of the testing section 2. In one aspect, the test material can comprise a medical implant 10. In this aspect, it is contemplated that the medical implant 10 can comprise one or more solid materials. It is further contemplated that the medical implant 10 can optionally comprise a substantially porous material. In an additional exemplary aspect, the medical implant 10 can be a conventional single-function sensor. In a further exemplary aspect, the medical implant 10 can be a conventional multi-function sensor. In still a further exemplary aspect, the medical implant 10 can be a container filled with one or more cells. In still another exemplary aspect, it is contemplated that the test material can comprise at least one alginate bead configured to elute at least one substance. In this aspect, the at least one alginate bead can comprise at least one single-alginate bead. Alternatively, the at least one alginate bead can comprise at least one multiple-alginate bead, such as a cross-linked alginate bead.

In a further aspect, it is contemplated that the outlet 24 of the test material housing 20 can be configured to removably receive the test material such that at least a portion of the test material is secured within the test material housing. In this aspect, and with reference to FIG. 1D, it is contemplated that the test material can comprise a medical implant 10 having an inner surface 12 that defines a bore 14 with at least one inlet 16 and at least one outlet 18. It is contemplated that each inlet 16 of the at least one inlet of the bore 14 of the medical implant 10 can be configured to receive the desired fluid 34. It is further contemplated that the medical implant 10 can be removably secured within the test material housing 20 such that the at least one inlet 16 of the bore 14 of the medical implant is positioned within the test material housing of the testing section 2. It is still further contemplated that the at least one outlet 18 of the medical implant 10 mounted within the test material housing 20 of the testing section 2 can be in fluid communication with the outlet 24 of the test material housing. In one exemplary aspect, the medical implant 10 can be mounted within the outlet 24 of the test material housing 20 of the testing section 2. It is contemplated that the medical implant 10 can be a conventional catheter, such as, for example and without limitation, a hydrocephalus shunt catheter, or a portion of a conventional catheter, such as, for example and without limitation, a ventricular catheter tip.

In an additional aspect, and with reference to FIG. 1C, the test material housing 20 can be configured to receive at least a portion of a tissue sample 90, including, for example and without limitation, a choroid plexus tissue sample. In this aspect, it is contemplated that the tissue sample 90 can be positioned within the test material housing 20 proximate the medical implant 10 such that the tissue sample contacts at least a portion of the medical implant. It is further contemplated that the tissue sample 90 can be positioned within the medical implant 10. In one aspect, the tissue sample 90 can be native tissue. In an alternative aspect, the tissue sample 90 can be an in vitro tissue construct. In an exemplary aspect, the tissue sample 90 can be an in vitro whole tissue model. In this aspect, it is contemplated that the in vitro whole tissue model can be configured to mimic the choroid plexus. In an exemplary aspect, the in vitro whole tissue model can be prepared by creating layers of epithelial cells and/or choroid plexus ependymal cells that are removed as entire tissues from a culture area, such as, for example and without limitation, polystyrene dishes coated with temperature-sensitive poly(N-isopropylacrylamide). In an alternative exemplary aspect, the in vitro whole tissue model can be prepared by seeding one or more layers of epithelial cells on a polymer, such as, for example and without limitation, an acrylate-based polymer with cultured cells, that mimics the thickness and mechanical integrity of the choroid plexus.

In an exemplary aspect, the in vitro whole tissue model can be configured to mimic the mechanical and physiological properties of native ventricular walls in the presence of catheter tubing or other medical implants. Thus, it is contemplated that the in vitro whole tissue model can be configured to mimic, for example and without limitation, the extent of surface contact and mass effect due to larger encapsulations and/or in-growth into a native ventricular wall, the combined effects of multiple cell types interacting with each other, the production of extracellular matrix elements, the growth of new cells within the tissue, and the vascular effects of capillary beds and the blood-tissue/CSF barrier. In an exemplary aspect, it is contemplated that the in vitro whole tissue model can comprise at least two different cell types, including, for example and without limitation, surface epithelial cells, glial cells, and supraependymal macrophages. In this aspect, it is further contemplated that the in vitro whole tissue model can comprise at least two layers for each cell type. It is still further contemplated that the in vitro whole tissue model can comprise cells that survive for a desired period of time, such as, for example and without limitation, at least 24 hours. It is still further contemplated that the in vitro whole tissue model can be sized and shaped such that it represents and approximates the spatial characteristics of native tissue. Thus, it is contemplated that the use of such an in vitro whole tissue model can provide an accurate simulation of contact between the medical implant 10 or other test material and the ventricular wall, which is known to be a major factor in cellular and/or tissue adhesion.

In a further aspect, and as shown in FIGS. 1A and 1C, the flow system 1 can comprise a pump 40 positioned between and in fluid communication with the inner chamber 32 of the fluid reservoir 30 and the inlet 4 of the testing section 2 (which can be (a) the inlet 16 of the bore 14 of the medical implant 10 or (b) the inlet 22 of the test material housing 20). In this aspect, the pump 40 can be configured to direct the desired fluid into the inlet 4 of the testing section 2. It is contemplated that the pump 40 can be placed in fluid communication with the fluid reservoir 30 and the testing section 2 using conventional tubing, including, for example and without limitation, thermoplastic polymer tubing, such as polydimethylsiloxane (PDMS), Marprene produced by Watson-Marlow Pumps Group (Wilmington, Mass.), and the like (generally depicted by thick black lines that define a flow path within FIGS. 1A and 1C). It is contemplated that a particular tubing can be selected for usage within the flow system 1 for purposes of achieving desired flow parameters. More particularly, it is contemplated that the inner diameter of the tubing can dictate the flow rate and/or pulsation rate within the flow system 1. Thus, selective variation of the inner diameter of the tubing within the flow system can cause desired changes in the flow and pulsatility achieved within the system 1. It is contemplated that the tubing within the system 1 can have a high compressive resistance such that the tubing can withstand at least about 240,000 compression cycles until failure. It is further contemplated that the total length of tubing within the flow system 1 can be minimized to reduce the likelihood of inappropriate cell/tubing interactions that may alter the performance of the flow system.

In one aspect, it is contemplated that the pump 40 can be a conventional peristaltic pump with rollers, such as, for example and without limitation, a Watson Marlow 401U/DM3 peristaltic pump. However, it is contemplated that the pump 40 can be any conventional pump, provided the pump is calibrated to desired flow and pulsation rates as described herein. In this aspect, the pump 40 can be configured to produce a desired flow rate of the desired fluid 34 ranging from about 0.002 mL per minute (mL/min) to about 36 mL/min, more preferably from about 0.10 mL/min to about 0.50 mL/min, and most preferably from about 0.20 mL/min to about 0.35 mL/min. It is contemplated that normal physiologic CSF flow rates can be about 0.30 mL/min, while hydrocephalic CSF flow rates can be about 0.25 mL/min. It is further contemplated that the pump 40 can be configured to direct flow of the desired fluid 34 to the inlet 16 of the bore 14 of the medical implant 10 at the desired flow rate such that at least a portion of the inner surface 12 of the medical implant contacts the desired fluid.

In another aspect, the pump 40 can be configured to have a pulsation rate ranging from about 4 pulses per minute (pulses/min) to about 400 pulses/min, and, more preferably, from about 70 pulses/min to about 280 pulses/min. It is contemplated that this range of pulsation rates can allow the flow system 1 to selectively approximate pulsation frequencies in adult, pediatric, and neonatal subjects. It is further contemplated that pulsatile flow can alter focal adhesion sites, impact cytoskeletal reorganization of cells, and decrease levels of Nuclear Factor-kappaB (NF-kB), which is involved in physiologic inflammatory responses. In a further aspect, the pump 40 can be configured to pump the desired fluid 34 such that the differential pressure of the desired fluid within the system ranges from about −1.66 mmHg to about 50 mmHg. It is contemplated that intra-luminal pressures can impact the expression of specific integrins, which will, in turn, impact receptor-ligand cell adhesion. It is further contemplated that the flow system 1 can be configured to mimic the physiologic shear stresses that can be experienced by a test material, such as a medical implant, within the body of a subject.

In another aspect, it is contemplated that the pump 40 can be configured to reverse the direction of flow of the desired fluid 34. Thus, it is contemplated that the pump 40 can be configured to selectively direct the desired fluid 34 into the outlet 6 of the testing section 2 and out of the inlet 4 of the testing section 2 toward the pump 40. It is contemplated that the pump 40 can be selectively controlled to mimic directional flow of fluid within the brain of a subject.

In one exemplary aspect, and as shown in FIG. 1A, the testing section 2 can be substantially vertically fixated therebetween the pump 40 and the fluid reservoir 30. In another exemplary aspect, the testing section 2 can be substantially horizontally fixated therebetween the pump 40 and the fluid reservoir 30. Thus, when the testing section 2 comprises a medical implant 10 that is directly inserted into the flow pathway (without a housing), the medical implant can be selectively fixated in either a substantially horizontal or a substantially vertical position therebetween the pump 40 and the fluid reservoir 30. Similarly, when the testing section comprises a test material housing 20, the test material housing can be selectively fixated in either a substantially horizontal or a substantially vertical position therebetween the pump 40 and the fluid reservoir 30.

In another exemplary aspect, and with reference to FIG. 1A, it is contemplated that the in vitro pulsatile flow system 1 can comprise a plurality of testing sections 2 as described above. It is further contemplated that the plurality of testing sections 2 can be placed in a parallel orientation such that multiple test materials can simultaneously be examined within the flow system 1. In this aspect, it is contemplated that the pump 40 can be a multi-channel pump to allow for simultaneous fluid communication with the plurality of testing sections 2.

In still a further aspect, and as shown in FIGS. 1A and 1C, the flow system 1 can comprise a first pressure valve 50 positioned between and in fluid communication with the outlet 6 of the testing section 2 and the inner chamber 32 of the fluid reservoir 30. In this aspect, the first pressure valve 50 can be configured to control and/or modulate flow of the desired fluid 34 between the outlet 6 of the testing section 2 and the inner chamber 32 of the fluid reservoir 30. It is contemplated that the first pressure valve 50 can be selectively opened and closed to control flow of the desired fluid 34. In one aspect, the first pressure valve 50 can be a high pressure valve. In one exemplary aspect, the first pressure valve 50 can be a flushing valve having an injectable reservoir, such as, for example and without limitation, a Heyer-Schulte® Pudenz flushing valve manufactured by Integra LifeSciences Corporation (Plainsboro, N.J.). It is contemplated that, when the first pressure valve 50 comprises a flushing valve having an injectable reservoir, a syringe can be used to penetrate the reservoir and withdraw desired fluid such that the cell count within the desired fluid achieves a desired level. However, it is contemplated that the first pressure valve 50 can comprise any conventional pressure valve.

In an additional aspect, and with reference to FIGS. 1A and 1C, the flow system 1 can further comprise a pressure sensor 60 for measuring fluid pressure of the desired fluid 34. In this aspect, it is contemplated that the pressure sensor 60 can be positioned between and in fluid communication with the pump 40 and the inlet 4 of the testing section 2. It is contemplated that the pressure sensor 60 can be a conventional pressure sensor mounted in fluid communication with tubing between the pump 40 and the testing section 2. Alternatively, the pressure sensor 60 can comprise a conventional manometer that is calibrated to ambient pressure and that is removably positioned within tubing between the pump 40 and the testing section 2.

In a further aspect, the flow system can comprise means for modulating flow of the desired fluid between the inner chamber of the fluid reservoir and the pump or, alternatively, between the pump and the inlet 4 of the testing section 2. The means for modulating flow is referred to generally in FIGS. 1A and 1C as element 70 and is described below and depicted as being positioned between the fluid reservoir 30 and the pump 40; however, it is understood that the following description is equally applicable to flow systems having a corresponding means for modulating flow that is positioned in between the pump and the inlet of the testing section.

In one aspect, it is contemplated that the means for modulating flow of the desired fluid can comprise a second pressure valve positioned between and in fluid communication with the inner chamber of the fluid reservoir 30 and the pump 40. It is further contemplated that the second pressure valve can be configured to control flow of the desired fluid 34 between the fluid reservoir 30 and the pump 40. It is still further contemplated that the second pressure valve can be selectively opened or closed to control flow of the desired fluid 34.

In another aspect, it is contemplated that the inner chamber 32 of the fluid reservoir 30 can be positioned in fluid communication with the pump 40 through a tubing assembly that comprises at least one tube. In this aspect, the means for modulating flow of the desired fluid therebetween the inner chamber of the fluid reservoir and the pump can comprise a reduced-diameter tubing section having a diameter that is less than the diameter of each respective adjoining tube within the tubing assembly. In one aspect, the reduced-diameter tubing section can comprise tubing, such as, for example and without limitation, Marprene tubing, having an inner diameter ranging from about 0.25 mm to about 0.50 mm. In this aspect, it is contemplated that the tubing can optionally have a 64 Shore durometer. In various aspects, it is contemplated that a particular tubing can be selected for purposes of achieving desired flow parameters. More particularly, it is contemplated that the means for modulating flow of the desired fluid can comprise a section of tubing having an inner diameter that dictates the flow rate and/or pulsation rate within the flow system. Thus, it is contemplated that selective variation of the inner diameter of the tubing within the flow system can cause desired changes in the flow and pulsatility achieved within the system. It is still further contemplated that tubing having a smaller diameter can be used to maintain flow at levels that simulate physiologic conditions. For example, in an exemplary aspect, it is contemplated that an inner tubing diameter of about 0.38 mm in between the fluid reservoir and the pump can yield a bulk flow rate of 0.25 mL/min and a pulsation rate of 100 pulses/min, thereby mimicking hydrocephalic flow in a pediatric patient.

Alternatively, in another aspect, the means for modulating flow of the desired fluid between the inner chamber of the fluid reservoir and the pump can comprise a clamp that selectively constricts the tubing between the fluid reservoir 30 and the pump 40. In this aspect, the clamp can be configured to intermittently constrict the tubing such that the inner diameter of the tubing mimics physiologic conditions during pulsatile flow within the brain of a subject. In a further aspect, the means for modulating flow of the desired fluid between the inner chamber of the fluid reservoir and the pump can comprise a filter positioned within the flow system. In still a further aspect, the flow system can comprise a flow sensor for monitoring the flow rate of the desired fluid. In an exemplary aspect, the flow sensor can be positioned between the fluid reservoir and the pump.

Optionally, in another aspect, and as shown in FIG. 1A, the flow system 1 can further comprise a gas reservoir 80 having an inner chamber. In this aspect, the inner chamber of the gas reservoir 80 can be configured to contain at least one gas for injection into the desired fluid 34. It is contemplated that the at least one gas can comprise, for example and without limitation, at least one of oxygen, carbon dioxide, hydrogen, and nitrogen. It is further contemplated that the gas reservoir 80 can be positioned between and in fluid communication with the pump 40 and the inlet 4 of the testing section 2.

Optionally, in a further aspect, the flow system 1 can further comprise means for adjusting the temperature of the flow system. In this aspect, it is contemplated that the means for adjusting the temperature of the flow system can be positioned proximate desired portions of the flow system. It is contemplated that the means for adjusting the temperature of the flow system can comprise heating cords, such as those manufactured by Gas-Col, Inc. (Terre Haute, Ind.). It is further contemplated that the means for adjusting the temperature of the flow system can comprise a conventional hot plate. In one aspect, the means for adjusting the temperature of the flow system can comprise a conventional incubator that is configured to receive the flow system. In this aspect, it is contemplated that, during operation of the flow system 1, the temperature within the incubator can be maintained at about 37° Celsius. However, it is contemplated that the means for adjusting the temperature of the flow system can comprise any conventional heating mechanism that is configured to adjust the temperature of the disclosed flow system. In another aspect, the means for adjusting the temperature of the flow system can have a thermal output configured to effect an adjustment in the temperature of the flow system. In this aspect, it is contemplated that the thermal output of the means for adjusting the temperature of the flow system can be selectively adjusted to mimic conditions of the brain of a subject. In some aspects, the thermal output of the means for adjusting the temperature of the flow system can be decreased to lower the temperature of the flow system, thereby mimicking brain cooling, such as occurs under neuroprotective conditions. In other aspects, the thermal output of the means for adjusting the temperature of the desired fluid can be increased to increase the temperature of the flow system, thereby mimicking brain warming, such as occurs during intracranial infection. In a further aspect, the flow system can comprise a conventional thermometer for monitoring the temperature of the flow system. It is contemplated that the means for adjusting the temperature of the flow system can comprise a controller that is configured to adjust the thermal output of the means fur adjusting the temperature of the flow system such that the temperature of the flow system is maintained at a desired temperature. As used herein, the term “temperature of the flow system” is intended to include the temperature of individual components of the flow system, as well as the temperature within and throughout the flow system as a whole.

In use, the described in vitro pulsatile flow systems can be incorporated into a variety of testing and monitoring methods. The disclosed methods can comprise positioning the test material as described herein and delivering the desired fluid to the test material as described herein. It is contemplated that the test material can be a medical implant having an inner surface that defines a bore as described herein. Optionally, the disclosed methods can comprise positioning a tissue sample in contact with at least a portion of the test material as described herein.

In one aspect, a method for measuring occlusion of at least one opening of the test material can comprise measuring the occlusion of the at least one opening of the test material following delivery of the desired fluid to the test material. In this aspect, it is contemplated that the method can comprise measuring occlusion of the bore of a medical implant as described herein.

In another aspect, a method for monitoring adhesion of cells to a test material can comprise monitoring adhesion of cells to at least one surface of the test material following delivery of the desired fluid to the test material as described herein. In this aspect, it is contemplated that the method can comprise monitoring adhesion of cells to a medical implant as described herein. As discussed herein, it is contemplated that adhesion of cells can be monitored using conventional mechanisms, including, for example and without limitation, manual counting, performing a Trypan blue exclusion assay, staining the medical implant using conventional methods, conventional post-hoc trypsinization, conventional protease digestion, conventional scanning electron microscopy analysis, and conventional photometric and microscopic analyses. In one aspect, the adhesion of cells can be monitored using a staining protocol for astrocytes and macrophages, such as the GFAP/DAPI staining protocol, the actin/vinculin/DAPI staining protocol, and the like.

In an additional aspect, a method for screening at least one compound can comprise introducing the at least one compound into the desired fluid prior to or during delivery of the desired fluid to the test material. Following the introduction of the at least one compound into the desired fluid, the method can comprise monitoring the adhesion of cells to at least one surface of the test material and/or occlusion of at least one opening of the test material. It is contemplated that the at least one compound can be configured to inhibit adhesion of cells to the test material. It is further contemplated that the at least one compound can be configured to inhibit occlusion of the openings of the test material. In one aspect, the test material can be a medical implant having a bore and at least one inlet.

In a further aspect, a method of screening for a composition that reduces or inhibits adhesion of at least one component of the desired fluid to a test material is disclosed. In this aspect, it is contemplated that the at least one component can comprise at least one of cells, proteins, and tissue. In one aspect, the method can comprise introducing a test composition into the desired fluid. In another aspect, the method can comprise determining inhibition of adhesion of the at least one component to the test material. In this aspect, it is contemplated that inhibition of adhesion of the at least one component to the medical implant can indicate that the test composition reduces or inhibits adhesion of the at least one component to the test material. In a further aspect, the test material can be a medical implant as described herein.

In another aspect, a method of screening for an inhibitor that reduces or inhibits adhesion of at least one component of the desired fluid to the test material is disclosed. It is contemplated that the inhibitor can be, for example and without limitation, an antibody, a small molecule, protein, peptide, and functional nucleic acid. As used herein, however, the term “inhibitor” refers to any substance or agent that can reduce or inhibit adhesion of at least one component of the desired fluid. In one exemplary aspect, the inhibitor can be minocycline, which can inhibit microglial cells. In another exemplary aspect, the inhibitor can be a statin. In this aspect, it is contemplated that the at least one component can comprise at least one of cells and tissue. In one aspect, the method can comprise introducing a test inhibitor into an in vitro pulsatile flow system as described herein, such as by, for example and without limitation, introducing the test inhibitor into the fluid reservoir or the test material housing of the flow system. In an additional aspect, the test material can be a medical implant having a bore with at least one inlet and an outlet as described herein. In this aspect, it is contemplated that the step of introducing the test inhibitor into the in vitro pulsatile flow system can comprise inserting the medical implant within the system such that the inlet of the bore of the medical implant receives the desired fluid as described herein. It is still further contemplated that the step of introducing the test inhibitor into the in vitro pulsatile flow system can comprise inserting the medical implant into the outlet of a test material housing as described herein such that at least a portion of the medical implant is positioned within the test material housing. It is still further contemplated that the outlet of the test material housing can be configured to removably receive the medical implant. In another aspect, the method can comprise determining inhibition of adhesion of the at least one component to the medical implant. In this aspect, it is contemplated that inhibition of adhesion of the at least one component to the medical implant can indicate that the test inhibitor reduces or inhibits adhesion of the at least one component to the medical implant.

In one exemplary aspect, a method for screening for a medical implant that reduces or inhibits infiltration of at least one tissue into an inlet of the bore of the medical implant is disclosed. In this aspect, it is contemplated that the at least one tissue can comprise a choroid plexus explant from a mammalian tissue source, such as, for example and without limitation, a rat, pig, human, and the like. In one aspect, the method can comprise introducing the medical implant into an in vitro pulsatile flow system as described herein. It is contemplated that the bore of the medical implant can have at least one inlet and an outlet as described herein. It is further contemplated that the step of introducing the medical implant into the in vitro pulsatile flow system can comprise inserting the medical implant into the outlet of a test material housing as described herein such that an inlet of the bore of the medical implant is positioned within the test material housing as described herein. It is still further contemplated that the outlet of the test material housing can be configured to removably receive the medical implant. In an additional aspect, the method can comprise introducing the at least one tissue into at least one of the fluid reservoir and the test material housing of the flow system. In another aspect, the method can comprise determining inhibition of infiltration of the at least one tissue into the medical implant. In this aspect, it is contemplated that inhibition of infiltration of the at least one tissue into the medical implant can indicate that the medical implant reduces or inhibits infiltration of the at least one tissue into the medical implant.

In exemplary aspects, the disclosed methods for monitoring adhesion of cells can be combined to simultaneously screen for both medical implants, test compounds, and/or test inhibitors that reduce or inhibit adhesion of cells to a medical implant as further described herein.

In other aspects, it is contemplated that the described systems can function as in vitro intracranial models. In one aspect, the described systems can be used to produce an in vitro model for simulating alterations in intracranial pressure and cerebrospinal fluid flow within the skull of a subject. In another aspect, the described systems can be used to produce an in vitro model for hydrocephalus within the skull of a subject.

### EXPERIMENTAL EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

Astrocyte cultures were collected from rat fetuses. Immediately after the dam had been euthanized with carbon dioxide, rat fetuses were extracted for astrocyte cultures at day 20 of gestation. The meninges of the embryos were removed, and brain tissue was minced and suspended in phosphate buffer solution (PBS) containing 1 mg/mL DNase with manganese and 1× trypsin. After a 10-min centrifugation at 275×g, the sample was re-suspended, sieved through an 80-μm nylon mesh, and washed with Hank's balanced salt solution (HBSS). The suspension was seeded and allowed to reach confluency. A shake-off procedure separated adherent astrocytes from other cell types. Flow cytometry confirmed the presence of high glial fibrillary acidic protein (GFAP) in the dissociated cells. Rat astrocytes were cultured in RPMI-1640 with 25 mM 4-(2-hydroxyethyl)-1-piperazineethanesulfonic acid (HEPES), 1% penicillin-streptomycin (Sigma, St. Louis, Mo.), 1% GlutaMAX (Invitrogen, Carlsbad, Calif.), and 10% fetal bovine serum (FBS, Sigma). Cultures were split at 80% confluence.

Twenty-four (24) hours before cell detachment for experimental analysis, cells were soaked in a low concentration of albumin-rich medium (0.5% FBS with an albumin additive) to mimic both the total protein (208.1 mg/L) and the albumin concentration (155 mg/L) of normal cerebrospinal fluid (CSF). After several washing steps with non-cationic Dulbecco's phosphate buffer solution (DPBS, Invitrogen), astrocytes were exposed to 1× TryplE Express (Invitrogen) to initiate re-suspension. After a 5-min incubation period, astrocytes were removed and added to medium, which was centrifuged at 275×g for 10 min before cells were suspended in fresh medium. Using the Trypan blue exclusion test, viable cells were counted using a hemocytometer. Viable cells were seeded and suspended at a density of 180.175 cells/mm² in either the static culture or the bioreactor.

Silicone surfaces were prepared in 6-well culture plates to represent a static in vitro culturing environment in which cells were seeded onto silicone rather than the culture dish base polymer polystyrene. Silicone was prepared using the Sylgard 184 Silicone Elastomer Curing Agent and Base (Dow Corning, Midland, Mich.) at a ratio of 10:1. Approximately 1 mL of the combined solution was injected into each well and allowed to cure at a temperature of 60° C. for 4 h before seeding with astrocytes.

Samples were analyzed for acute cell maturation and growth. Astrocytes (0.098×106 cells) were seeded onto a silicone surface to yield a density of 180.175 cells/mm². Astrocytes were incubated for 20 h at 37° C.

Astrocytes were suspended on a silicone surface at 180.175 cells/mm² equating to a final astrocyte suspension of 4.615×104 cells/mL (3×106 cells total) in a pulsatile flow system as described herein. Astrocytes were propelled through the system at 37° C. The cells were distributed using an autoclaved 250-mL spinner flask (Cytostir, Kimble Chase, Vineland, N.J.). A three-channel peristaltic pump (Watson-Marlow 401U/DM3, Cornwall, England) initiated flow propagation through a series of tubing including Marprene double manifold tubing (Watson-Marlow), barium-impregnated regions of silicone catheters, and barium-free silastic tubing (Silastic Rx Medical Grade Tubing, Dow Corning, Midland, Mich.). The rate of flow was set to mimic conditions within the ventricular cavity such that variations in pressure, flow rate, and pulsatility were independent parameters (pump settings were chosen based on Watson-Marlow pump and tubing specifications). Conditions of high pressure (16.43±0.24 mm Hg) were induced using inline high-pressure valves (Baxter Heyer-Schulte Mini-LPV High Pressure Valves, Deerfield, Ill.), whereas low-pressure conditions (−1.66±0.02 mm Hg) resulted from inherent pressure within the system with no valve used.

Flow rate and pulsation rate were manipulated in combination by varying the diameter of the Marprene tubing: 0.25 mL/min and 100 pulses/min was simulated using 0.38-mm inner diameter tubing; 0.3 mL/min and 120 pulses/min was simulated using 0.38-mm inner diameter tubing; 0.25 mL/min and 70 pulses/min was simulated using 0.50-mm inner diameter tubing, and 0.25 mL/min and 200 pulses/min was simulated using 0.25-mm inner diameter tubing. 70 pulses/min is the average pulse of the adult population. 100 pulses/min is the average pulse of the pediatric population. 200 pulses/min is the average pulse of neonatal population. 0.25 mL/min is the approximate CSF formation rate of individuals with chronic hydrocephalus. 0.30 mL/min is the approximate CSF formation rate of individuals without hydrocephalus.

When measuring adhesion under varying conditions of flow, no pressure valve was used and pulsation rate was set to 100 pulses/min. When measuring adhesion under varying conditions of pressure, 0.25 mL/min flow rate and 100 pulses/min were used. When measuring adhesion under varying conditions of pulsatility, no pressure valve was used and flow rate was set to 0.25 mL/min. A removable in-line manometer was used to record mean pressure within the catheter. Sample regions of medical-grade silicone shunt tubing impregnated with barium were fixed in horizontal and vertical positions to mimic prolonged supine and upright orientation, respectively (FIG. 1). Sample tubing was obtained from the Neurosurgery Division of Medtronic (Goleta, Calif.).

An Extech HD700 Handheld Digital Manometer was used to measure pressure within the flow system. The total pressure in all components of the flow system was obtained when the manometer was set to zero at atmospheric pressure. The pressure of fluid flow was determined when the manometer was zeroed in line with the system turned off. Pressure values were confirmed manually using a water column.

To observe alterations in adhesion before cell death occurred, cells were driven through the system for 20 hours. Although the concentration was initially empirical, a suspension of 3×10⁶ astrocytes in 65 mL of albumin-rich medium was ultimately propelled through the flow system, which was an attempt to model the physiologic event of adhesion dependent occlusion. Medium was used to keep the cells alive for as long of a period as possible. After 20 h of incubation, samples were removed and prepared for staining.

Following cell exposure to silicone, astrocytes bound to each substrate were fixed in 4% (w/v) paraformaldehyde in PBS for 2 h at ambient temperature. All samples were removed from solution, immediately rinsed, stored in 0.1 M PBS overnight at 4° C., and then longitudinally cut to prepare for staining. Samples inoculated with astrocytes were batch stained with a 1:300 concentration of mouse anti-GFAP (Chemicon, Temecula, Calif.) in 0.1 M PBS to label astrocytes. A 1:100 goat anti-mouse IgG (H+L) fluorescein conjugated secondary antibody (Chemicon, Temecula, Calif.) was applied for 1 h at 37° C. to localize the GFAP primary antibody. The sections were then counterstained with the nuclear dye 4′,6-diamidino-2-phenylindole (DAPI) diluted from 1 mg/mL stock to 1:1000 in 0.1 M PBS using established methods.

Confocal images were taken using a Zeiss 510 microscope, and spectral epifluorescent images were obtained using a Nikon fluorescent CRI Nuance microscope system. The confocal images were observed using the Zeiss LSM image browser. For semi-quantitative image analysis, two random spots on each tube half and on each static culture sample were investigated using DAPI-positive nuclei tracing (n=12, where each sample included both portions of the catheter tubing for HSCB analysis). Data were analyzed and represented as the percent of the entire surface area occupied by DAPI-positive staining.

For a second means of analysis, semi-quantitative data were pooled for the investigation of cellular aggregates (n=12, where each sample included both halves of the catheter tubing for HSCB analysis). After collection of the confocal images was completed, the samples were exposed to TrypLE Express (Gibco BRL, Rockville, Md.) to release cells from the tubing, which was then concentrated on a glass slide using a Shandon Cytospin 3 Cytocentrifuge (Fisher Scientific, Hampton, N.H.). Photometric analysis was performed using a luminance software tool (Neurolucida, Micro Bright Field, Williston, Vt.). Data for each condition were pooled and represented as the percent change from 255, with 255 representing complete light emission at each measured pixel.

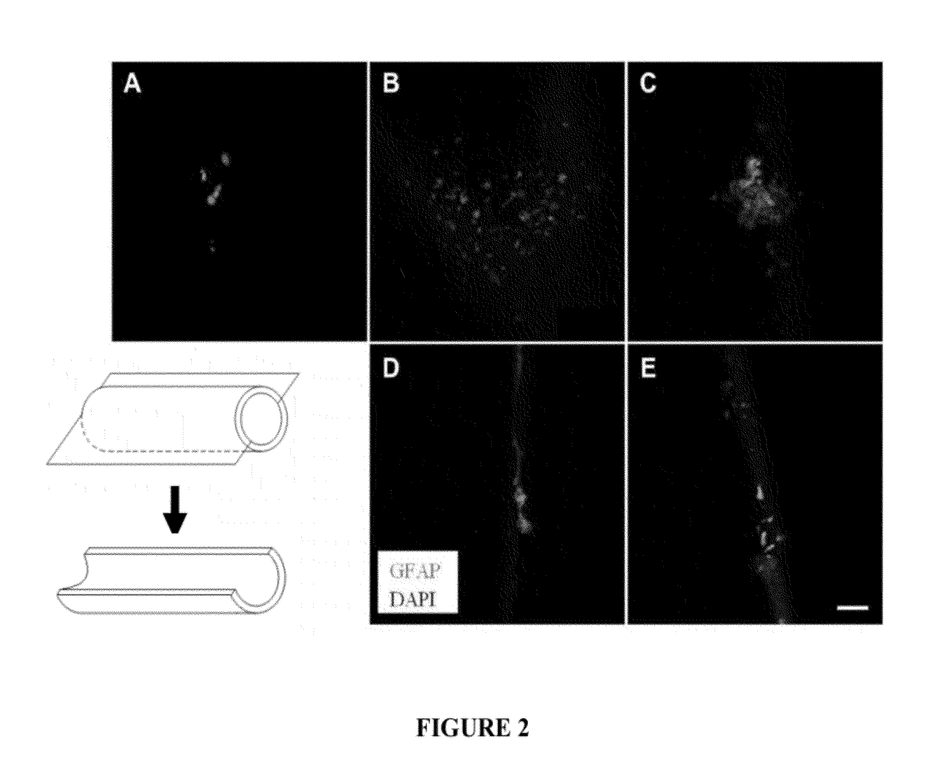

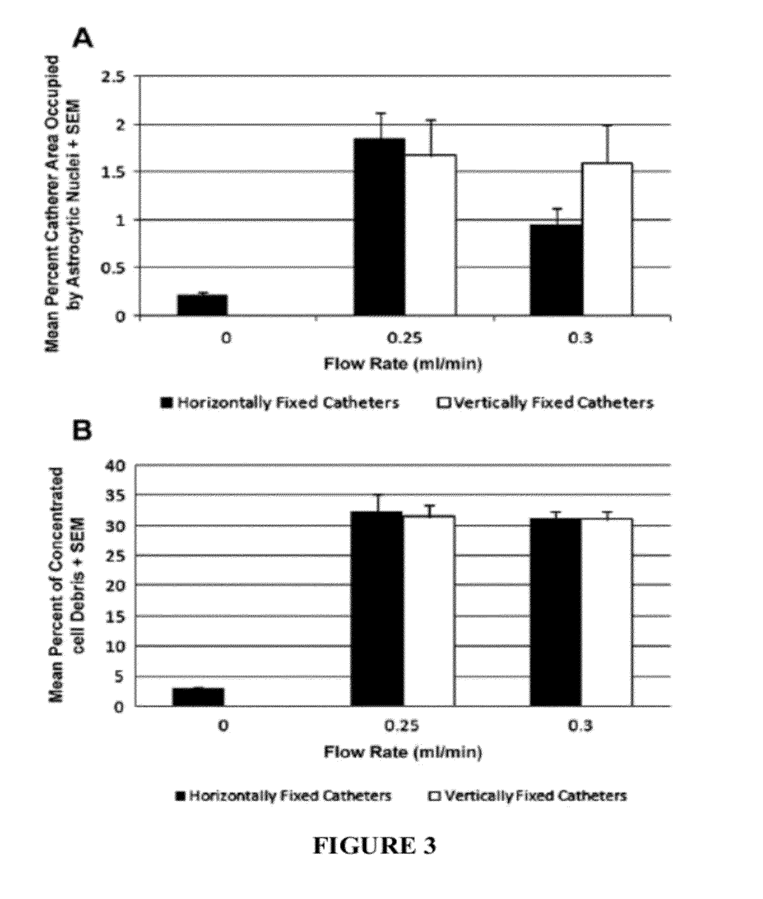

Calibration using 0.1 M PBS at corresponding pump settings and Marprene tubing diameters confirmed flow rates of 0 mL/min (static culture), 0.25 mL/min, and 0.30 mL/min. As seen in FIG. 2 and FIG. 3, fluid flux altered the quantity of binding astrocytes within a 20 h time period. The Kruskal-Wallis H test indicated that the samples acquired from nuclei tracing did not come from the same distribution (i.e., they had different amounts of adhesion). An unplanned comparison of mean ranks using the least significance in difference rank found a significant difference between the static culture (0 mL/min) and the horizontally fixed samples (0.25 mL/min flow and 0.3 mL/min). As in the data acquired by confocal microscopy, the total density of cell debris showed a statistically significant increase in adhesion when samples were exposed to 0.25 mL/min flow and 0.30 mL/min flow when compared with static culture (0 mL/min) using a post-hoc least significance difference in ranks. These data were normally distributed, with a power of greater than 99% when comparing debris densities in static culture to 0.25 mL/min and to 0.30 mL/min. FIG. 2A-FIG. 2C show cell attachment to horizontally fixed catheters and FIG. 2D-FIG. 2E show cell attachment to vertically fixed catheters at varying flow rates. Flow rates were 0 mL/min (FIG. 2A, static cultures), 0.25 mL/min (FIG. 2B and FIG. 2D), and 0.30 mL/min (FIG. 2C and FIG. 2E). Scale bar denotes 50 μm in all panels.

FIG. 3A shows the mean percent catheter area coupled by astrocytic nuclei under varying flow rates for both horizontally fixed catheters and vertically fixed catheters. Compared with static culture (n=12) denoted as 0 mL/min, tracing of positively stained nuclei exposed to 0.25 mL/min flow on horizontally fixed samples (n=12) was significantly elevated. Likewise, significantly more adhesion was observed at 0.30 mL/min (n=12) than in static culture. In static cultures, vertically oriented samples are not included in standard practice. No significant differences in adhesion were observed when comparing vertically fixed catheters (n=12 for each data set). FIG. 3B shows the mean percent of concentrated cell debris under varying flow rates for both horizontally fixed catheters and vertically fixed catheters. Using photometry to quantify the total volume of cells and cellular debris on catheters exposed to each flow rate of similar surface area, an elevated flow rate enhanced astrocyte adhesion. A sample size of 12 was used for each group of catheters.

Total mean recorded intra-luminal pressure was confirmed to be −1.66±0.02 and 16.43±0.24 mm Hg with and without in-line high pressure valves, respectively. Confocal images in FIG. 4 show no variation between adhesion under conditions of low or high pressure. A Mann-Whitney U test indicated that there was no significant difference between groups. A larger concentration of both GFAP for astrocytes and DAPI for nuclei can be seen in horizontally fixed catheters exposed to increased pressure. When samples were held vertically, these images revealed that the concentration of GFAP increased, and the concentration of DAPI remained relatively consistent. FIG. 4 shows confocal images of the cell attachment to horizontally fixed catheters (FIG. 4A-FIG. 4B) and vertically fixed catheters (FIG. 4C-FIG. 4D). In all panels, the scale bar represents 50 μm.

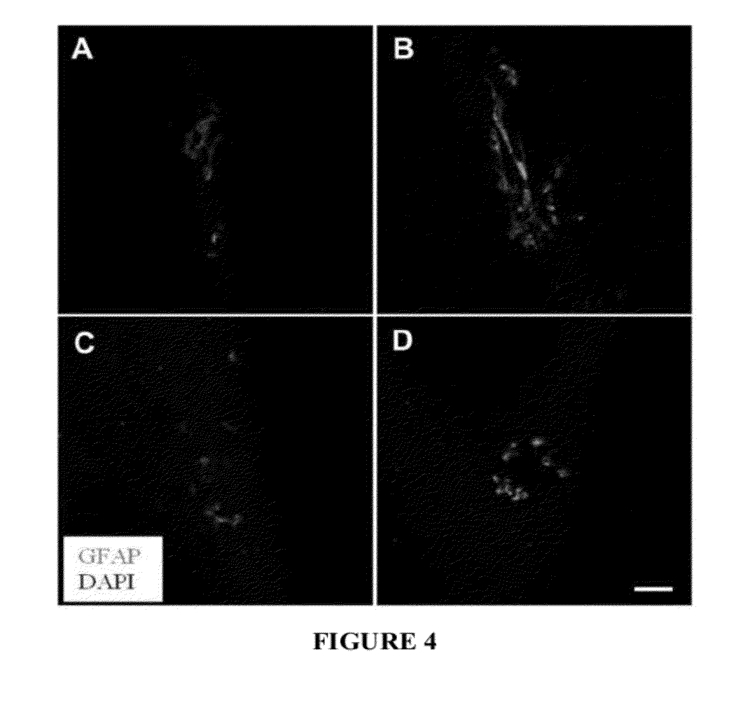

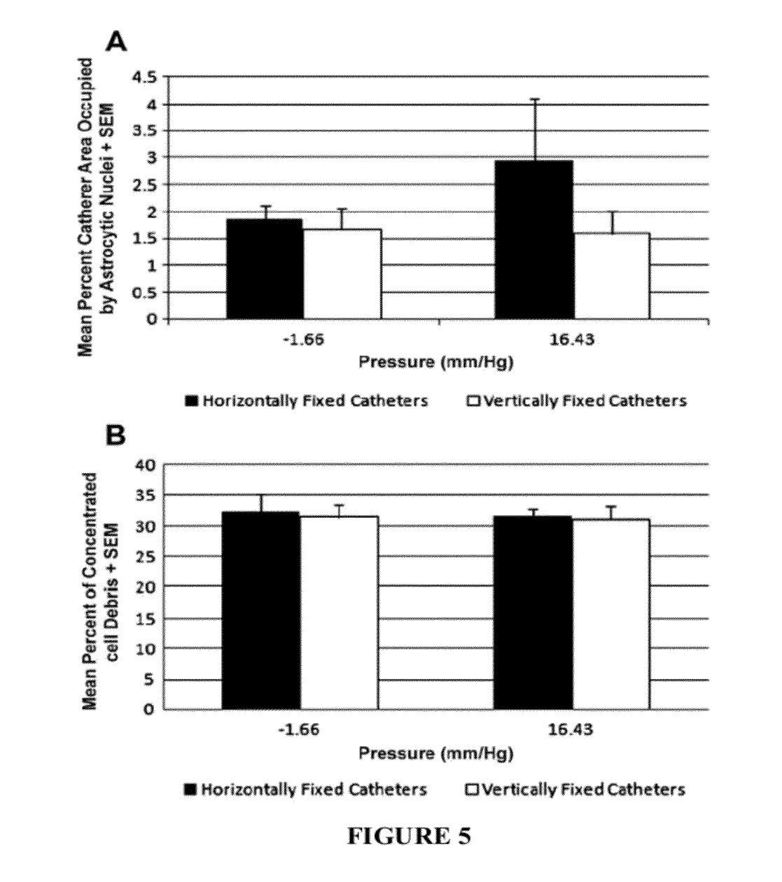

An increase in pressure did not significantly increase astrocyte adhesion in either horizontally fixed (P=0.205) or vertically fixed samples (P=0.239) (FIG. 5). Although there was a trend (P>0.05) that indicated that an increase in pressure when samples were held horizontally can increase adhesion, the likelihood of a false negative (the β error level) was calculated to be 85% for horizontally fixed samples. In contrast, all other β error levels were calculated to be less than 20%. When astrocytes and cell debris were collected and analyzed photometrically, no statistically significant difference was found between either horizontally fixed or vertically fixed samples.

FIG. 5A shows the mean percent catheter area coupled by astrocytic nuclei under varying pressures. A sample size of 12 was used for each group of catheters. FIG. 5B shows the mean percent of concentrated cell debris under varying pressures for both horizontally fixed catheters and vertically fixed catheters. A sample size of 12 was used for each group of catheters.

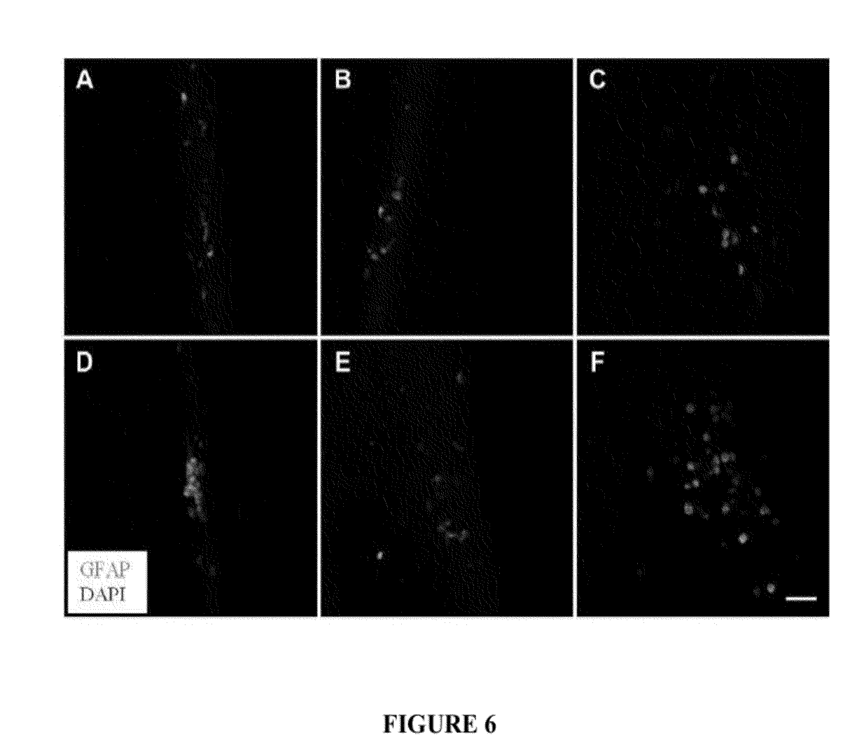

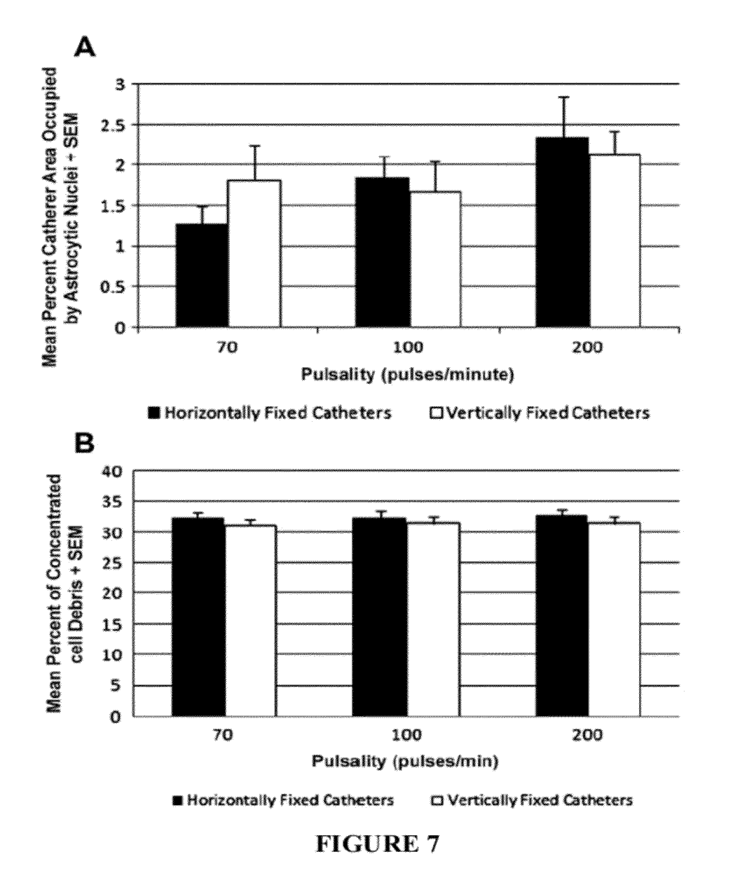

The effect of pulsation rate on astrocyte adhesion is shown in FIG. 6 and FIG. 7. Clumping of adherent astrocytes was observed. A Kruskal-Wallis H test indicated that the samples came from the same distribution when pulsation rate was varied (P=0.331). Analysis with photometry revealed no significant variation in samples, indicating that the samples came from the same distribution. FIG. 6 shows cell attachment to horizontally fixed catheters (FIG. 6A-FIG. 6C) and vertically fixed catheters (FIG. 6D-FIG. 6F) at varying pulsation rates. In FIG. 6A and FIG. 6D, the pulsation rate was 70 pulses/min. In FIG. 6B and FIG. 6E, the pulsation rate was 100 pulses/min. In FIG. 6C and FIG. 6F, the pulsation rate 200 pulses/min. Morphologically, individual cells seem to be relatively round with only minor evidence of process extension. Scale bar denotes 50 μm.

FIG. 7A shows astrocyte adhesion dependency on pulsation rate acquired using nuclei tracing for both horizontally fixed catheters and vertically fixed catheters. A sample size of 12 was used for each group of catheters. FIG. 7B shows the total percent of concentrated cell debris that was calculated to compare astrocyte adhesion when the environmental pulsation rate was altered. A Kruskal-Wallis H test revealed no significant differences between groups. A sample size of 12 was used for each group of catheters.

### Example 2

To study the effect of the drainage hole size of the ventricular catheter, PDMS samples were designed with holes that varied from 282 to 975 μm in diameter. The number of holes was calculated such that the bulk flow rate (0.25 mL/min or approximately 4.2×10−9 m3/s) and total hole surface area (6.3×10−6 m2) were equal across all samples. The placement of the drainage holes across samples was designed to mimic the current clinical catheter by maintaining the distance between each hole (approximately 500 μm) and the number of hole rows (four). Two fabrication techniques were analyzed to attain drainage holes in PDMS: stereotactically guided punched holes, and hole production using nanofabrication techniques including photolithography and Bosch-like deep reactive ion etching (DRIE). Table 1 shows sample group number assignments and their calculated parameters. Approximate shear stress has been calculated assuming that the volumetric flow rate through each hole and the hole diameter remain constant.

TABLE 1

| | | Hole | Shear stress | |
|---|---|---|---|---|
| | | diameter | per hole | Hole |
| Group no. | Sample type | (μm) | (N/m² [symbol] | no. |
| 1 (control) | Industry punched tube | 500 | 0.0075 | 32 |
| 2 | Punched tube | 282 | 0.0134 | 101 |
| | | 500 | 0.0075 | 32 |
| | | 754 | 0.0050 | 14 |
| | | 975 | 0.0039 | 8 |

[symbol]

indicates data missing or illegible when filed

Holes were mechanically punched using a set of blunt-ended needles (Nordson EFD, Providence, R.I., USA). Commercially available catheter tubing without preexisting 500-μm holes (Medtronic, Inc., Goleda, Calif., USA) was cut into 4-cm lengths. At one end of each catheter segment, one drop of PDMS Sylgard 184 (1:10 catalyst/base by weight, Dow Corning, Midland, Mich., USA) was injected and allowed to cure for 30 min at 150° C. To assure that the silicone plug was cured and had sealed the lumen, distilled water was injected into the opposite end. Catheter segments were air-dried, individually placed in a stereotactic frame, and punched with blunt-ended needles. The smallest holes (with average hole diameter of 282 μm) were punched into the PDMS tubing using a 32-gauge blunt needle, one of the smallest sizes manufactured. The PDMS surface area and the total hole surface area of each catheter segment equaled the PDMS surface area and total hole surface area of the clinical hardware (4.7×10−4 and 6.3×10−6 m2, respectively; Table 1).

Scanning electron microscopy (SEM) was performed using a Quanta 600 under high vacuum. Images were acquired using a backscatter detector at both ×40 and ×400 magnifications. An optical profilometer (Zygo Corporation, Middlefield, Conn., USA) was used to detect reflected light using a 40-μm bipolar (10-s) scan length and attain root mean square (RMS) average roughness values. Samples were cut laterally such that the wall of the hole was exposed. Fringes were nulled by adjusting the roll/pitch. Values were averaged across the longitudinal plane of the hole wall to determine the effect of the cutting edge of the punch.

Mouse IC-21 peritoneal macrophages and rat primary astrocytes were attained and cultured using previously described methods. Briefly, macrophages were obtained from ATCC (SV-40 transformed peritoneal IC-21 macrophages, ATCC product no. TIB-186) and cultured in RPMI-1640 medium with 25 mM 4-(2-hydroxyethyl)-1-piperazineethanesulfonic acid (HEPES, Sigma, St. Louis, Mo., USA), 1% penicillin-streptomycin (Sigma), 1% GlutaMAX (Sigma), 1% sodium pyruvate (Invitrogen, Carlsbad, Calif., USA), and 10% fetal bovine serum (FBS, Sigma). Astrocytes were obtained through an extraction and shake-off process and cultured in RPMI-1640 medium with 25 mM HEPES, 1% penicillin-streptomycin, 1% Gluta-MAX, and 10% FBS. Both cultures were seeded in T-75 Culture Flasks (ISC Bioexpress, Kaysville, Utah, USA) and were split at 80% confluence. To mimic both the total protein (208.1 mg/L) and the albumin (155 mg/L) concentration of cerebrospinal fluid, a subset of macrophages and astrocytes intended for analysis were immersed in a low concentration of albumin-rich medium (0.5% FBS with an albumin additive) for 24 h before being detached and added to a cell adhesion assay.

A 5-min exposure to 1× TrypLE Express (Invitrogen) caused macrophages and astrocytes to detach from cell culture flasks. Once macrophages had been immersed in the enzyme solution for 5 min, physical dislodgement by striking the walls of the flasks sharply facilitated cell removal. Viable cells were counted on a hemocytometer using the Trypan blue exclusion test and suspended in the low protein medium at a final cell suspension of 4.615×104 cells/mL (3×106 cells total). The cellular solution was then added to a pulsatile flow system as described herein.

To mimic pulsatile flow conditions within the cerebral ventricles, the system used a three-channel peristaltic pump (Watson-Marlow 401U/DM3, Cornwall, England). The system included an encased PDMS catheter with drainage holes: PDMS catheters (groups 1 and 2) were suspended in plastic 1-mL syringes with the cannula removed (BD, FranklinLakes, N.J., USA). From a suspension flask, the system propelled a macrophage or astrocyte cell suspension toward the PDMS sample, through the holes of the sample, and out through the lumen of the catheter. A flow rate of 0.25 mL/min and a pulsation rate of 100 pulses/min were used in this study to imitate pulsatile, ventricular CSF flow under chronic hydrocephalus conditions. Adhesion was measured in and around the drainage holes after a 20-hour exposure period.

After the 20-hour exposure period, samples were removed and fixed with 4% (w/v) paraformaldehyde. To identify the cell nuclei of cells fixed to the samples, immunofluorescence was employed. Each sample was rinsed and stored overnight at 4° C. in 0.1 M PBS. For permeabilization, samples were incubated in 0.1% Triton X in 0.1 M PBS for 10 min. Fifteen minutes of exposure to anhydrous methyl alcohol confirmed permeabilization of the macrophages. Samples were stained with the nuclear dye 4′,6-diamidino-2-phenylindole (DAPI) diluted from 1 mg/mL stock to 1:1,000 in 0.1 M PBS using established methods.

After fluorescent staining, a Leica microscope was used to obtain epifluorescent images of the exterior surface of the catheter. Serial images were acquired from the catheter tip to the opposite end to (1) determine the total cell adhesion around all of the holes and (2) categorize data based on the position of the hole in relation to the catheter tip. Catheters were then rotated approximately 90° and re-imaged so that adhesion could be categorized based on the catheter orientation in the flow system (top, bottom, sides of catheter). With all image acquisition, the camera settings were fixed to an exposure of 702.5 ms. A sample size of six catheters was used for each experimental group with analysis including examination of adhesion around every hole. For analysis, DAPI channel images were loaded into ImageJ (National Institute of Health, Bethesda, Md., USA) [1] and converted to 16-bit images before the contrast was enhanced with saturated pixels set at 0.5%. The ellipse tool was used to construct circular area selections around each hole such that PDMS surface area to be analyzed was equal across all groups. The background was subtracted using a rolling ball radius of 25 pixels. Next, selected particles were analyzed where the threshold was adjusted to include only cell nuclei. Advantages to this method are that only pertinent (in focus) cell nuclei were analyzed without background problems, information on the percent area covered by cell nuclei could be acquired directly rather than through inferences based on intensity, and data were not dependent on the identification of the hole edge.

To compare adhesion across groups with more focus on the area surrounding each hole, a second analysis technique was performed. A custom software package was built to compute the average color in user-defined areas, including areas meant to distinguish holes, concentric rings surrounding the holes, and the image background. The average blue component in digital Red-Green-Blue space was determined using the DAPI channel from the epifluorescent acquired images. A normalized background was removed and data were reported as a percent from 0 to 255, with 255 representing brightest light emission. Although analysis using nuclei area is preferred in this study because of the aforementioned advantages, this additional measurement provides cell density data in fixed distances from the hole edge.

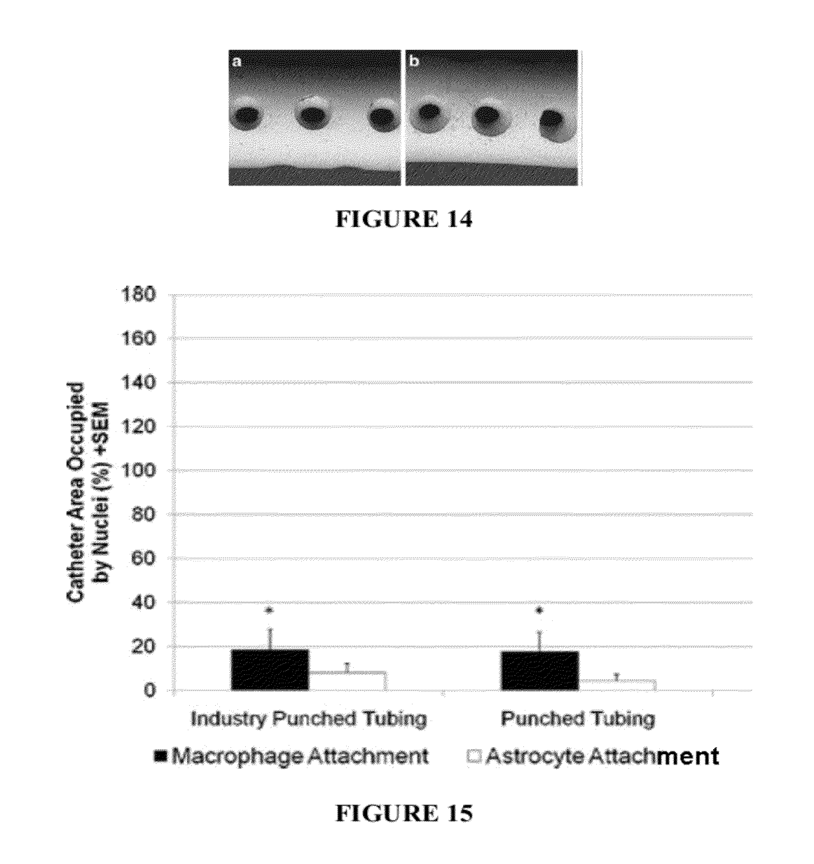

Light microscopy confirmed that holes were successfully created in all groups. The punching method in groups 1 and 2 created a larger hole diameter at the punch entry site than the diameter of the punch exit site (visual tapering is noted in FIG. 14).

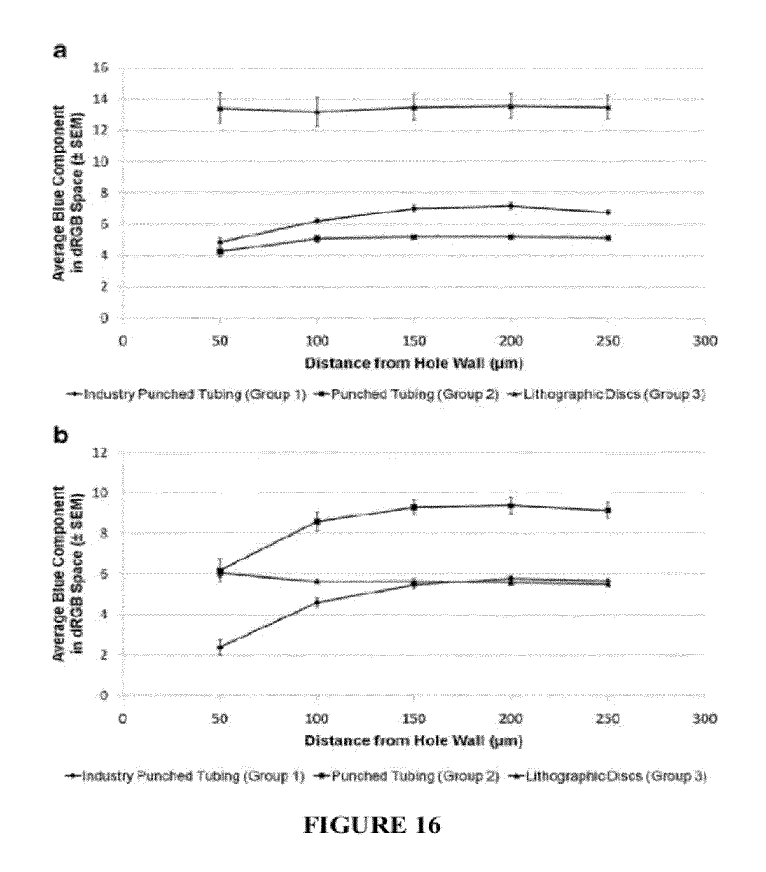

Fabrication methods across groups were compared by analyzing macroscopic (using SEM, FIG. 2) and microscopic (using optical profilometry, Table 2) roughness as well as macrophage and astrocyte adhesion on 500-μm samples. Macroscopic analysis suggested that group 2 holes had a linear textured surface. This was not apparent in group 1 samples and was likely due to imperfections in the punch. Analysis of the RMS roughness measurements between groups 1 and 2 revealed no significant difference in microscopic roughness. Adhesion results used to compare fabrication methods can be seen in FIGS. 15 and 16. There was a significant difference (P<0.05) in the degree of total macrophage attachment on group 3 discs compared to both the group 1 and 2 catheters, but there was no significant difference in adhesion of macrophages on group 1 and 2 catheters. There were no significant differences in total astrocyte adhesion. When adhesion was analyzed with respect to the distance from each hole edge, there was no significant difference in macrophage adhesion between groups 1 and 2. Astrocyte adhesion on group 1 and 2 catheters appeared to increase with increasing distance away from the hole until it plateaued at approximately 150 μm. At all intervals away from the hole edge but 50 μm, astrocyte adhesion was significantly greater (P<0.05) on group 2 catheters than on group 1 samples.

TABLE 2

| | Hole diameter | Roughness average |
|---|---|---|
| Group no. | measurements (μm) | (RMS) |
| 1 (control) | 500-2.4 | 1.12-0.5 |
| 2 | 281.7-35.5 | 1.10-0.4 |
| | 460.0-44.7 | 0.93-0.2 |
| | 753.8-12.4 | 0.88-0.3 |
| | 975.05-35.4 | 1.48-0.2 |

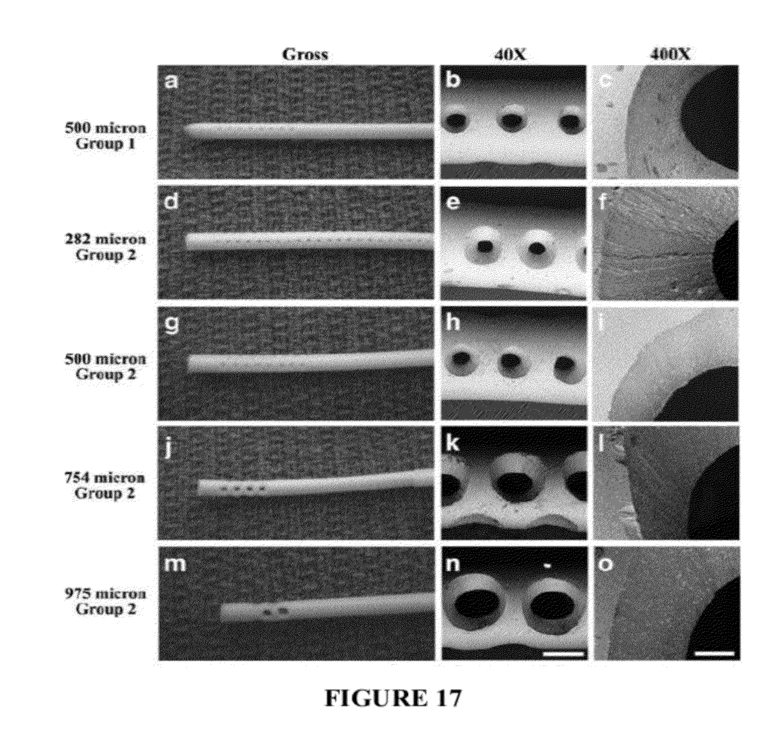

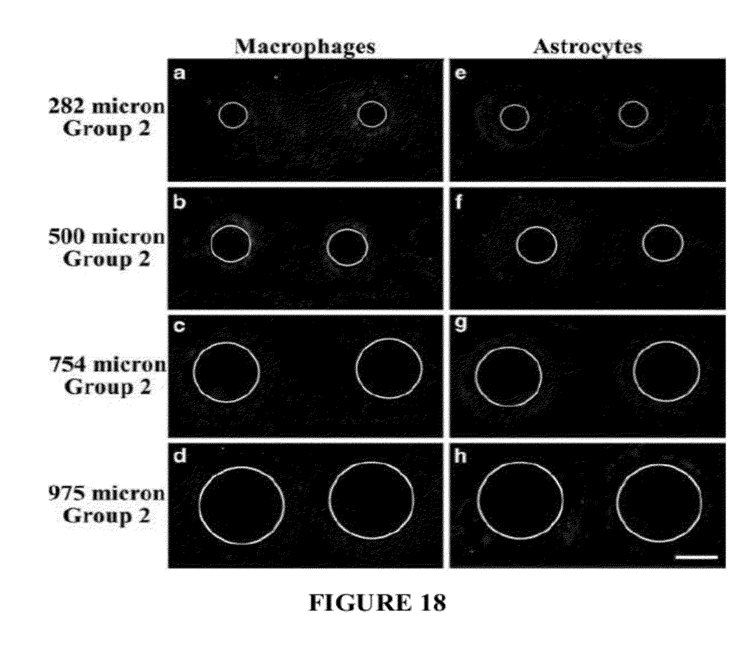

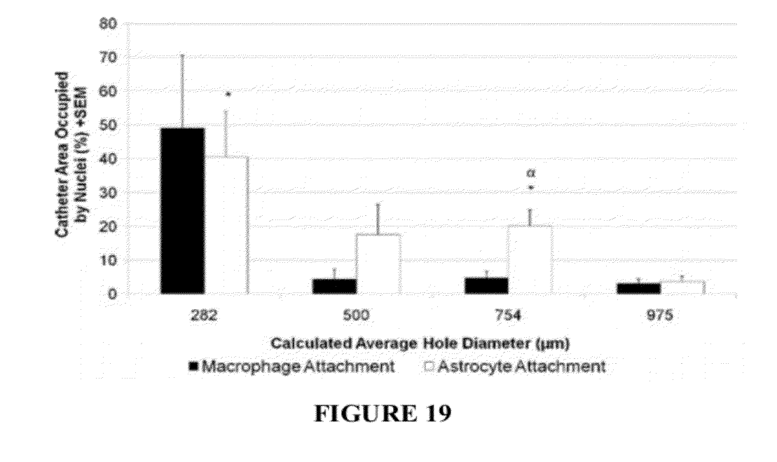

Fabricated catheters used to analyze variance in hole size can be viewed in FIG. 17. Measured hole diameters and RMS roughness values are shown in Table 2. There were no statistically significant differences in RMS roughness values, except when 754-μm samples were compared with 975-μm samples: 754-μm samples had a significantly smaller RMS value than did the 975-μm samples (P<0.05). The average total area the macrophage nuclei occupied on the catheter followed a trend from least to most adherent as hole diameters decreased, 975<754≈500<282; the average total astrocyte adhesion from least to most adherent followed a trend as hole diameters changed, 975<500<754<282 (FIGS. 18 and 19). A linear regression analysis with R2 values of 0.63 for macrophage adhesion and 0.84 for astrocyte adhesion implied a trend of decreasing adhesion with increasing hole diameter. None of the differences in adhesion were significant, however, except for the differences in astrocyte adhesion on 282- and 754-μm samples compared with astrocyte adhesion on 975-μm samples (P<0.05). On 754-μm samples, the difference between macrophage and astrocyte attachment was significant (P<0.05).

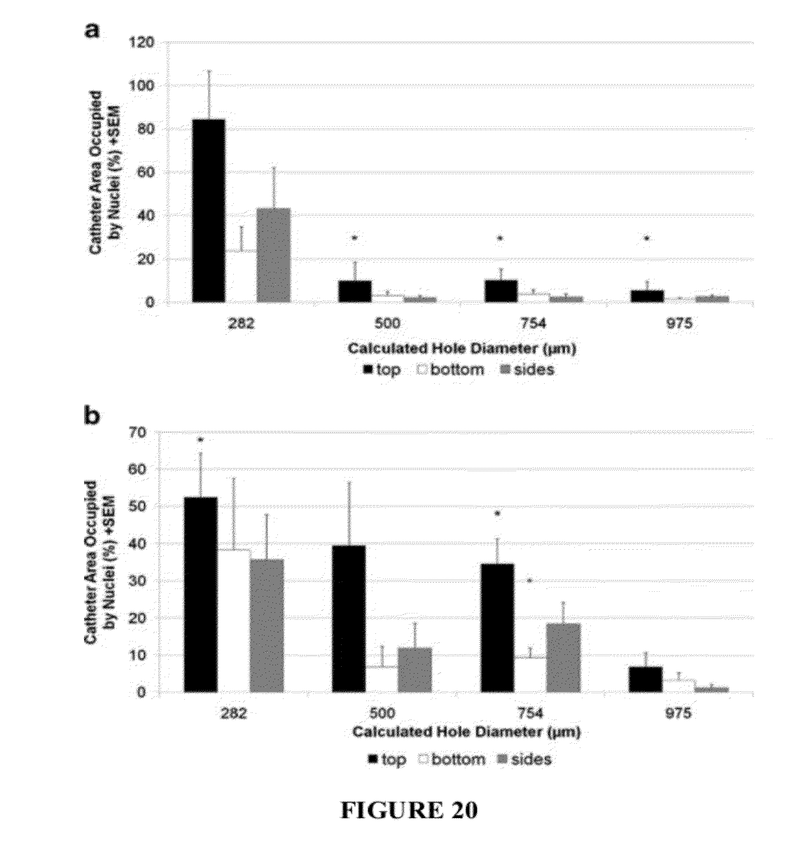

Macrophage and astrocyte adhesion appeared to occur predominantly on the top of the catheter (remembering that the catheter was horizontally fixed in the flow system as seen in FIG. 1). On the top of the catheter, there were significantly more macrophage nuclei on 282-μm samples than on 500-, 754-, or 975-μm samples (P<0.05), but there was also a significant difference in macrophage adhesion between 754-μm samples and 975-μm samples (P<0.05, FIG. 20). Astrocyte adhesion on 975-μm samples was significantly less than astrocyte adhesion on 282- and 754-μm samples. On the bottom of the catheter, there were no significant differences in macrophage adhesion and a significant difference in astrocyte adhesion between only 754-μm samples and 975-μm samples. Hole diameter did not create any significant differences in macrophage or astrocyte adhesion on the sides of the samples.

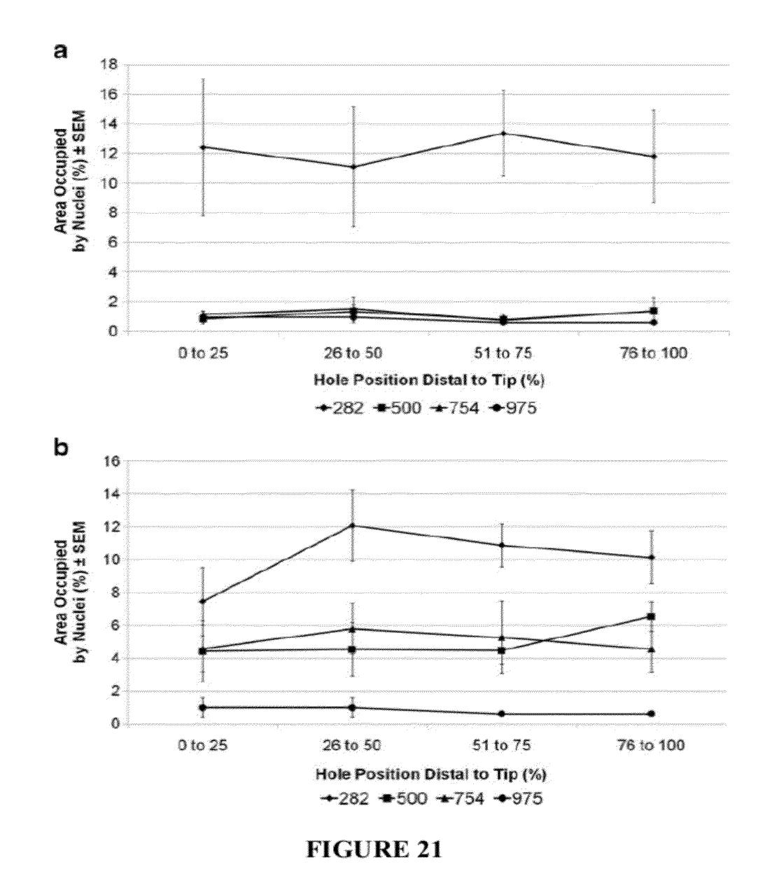

There were no obvious trends suggesting that adhesion was dependent on the proximity of the hole to the catheter tip (FIG. 21). This finding was confirmed using a one-way ANOVA, which revealed no statistically significant differences in adhesion on 282-, 500-, 754-, or 975-μm samples between the first, second, third, or fourth quarter of the holes. Closest to the tip, there was a significant difference in adhesion on 282-μm samples compared with 500-μm samples (macrophages), 754-μm samples (astrocytes), and 975-μm samples (astrocytes and macrophages). Adhesion in the latter half of the catheter (more distal to the catheter tip) was significantly greater on 282-μm samples compared with 500-, 754-, and 975-μm samples, independent of cell type.

### Example 3

In a flow system as described herein and depicted in FIG. 1, adjustable flow and pulsation rates were achieved using a three-channel peristaltic pump (Watson-Marlow® 401U/DM3, Cornwall, England), Marprene Tubing (thermoplastic polymer with inner diameter 0.2-0.5 mm, 64 Shore, Watson-Marlow), in-line transport tubing (PDMS with inner diameter 1.5 mm), a removable PDMS sample region (inner diameter 1.5 mm), and low total protein albumin-rich medium (0.5% fetal bovine serum (FBS) with an albumin additive). Shear stress, flow rate, and pulsation frequency were calculated using this design (Table 3). After initial development and confirmation that set parameters fell within given deviations, the cell type and cell concentration were chosen, the cell viability on a catheter and in solution (with respect to each system component and with respect to time) was analyzed, the most appropriate technique to measure cell attachment was determined, and the sample type (catheter lumen, catheter holes) was decided.

TABLE 3

| | | | | Outputted | |
|---|---|---|---|---|---|
| Marprene | Marprene | PDMS | PDMS | Bulk | Outputted |
| Inner | Shear | Inner | Shear | Volumetric | Pulsation |
| Diameter | Stress | Diameter | Stress | Flow Rate | Frequency |
| (mm) | (N/m²) | (mm) | (N/m²) | (mL/min) | (pulses/min) |
| 0.5 | 0.0301 | 1.5 | 0.0011 | 0.25 | 70 |
| 0.38 | 0.0686 | 1.5 | 0.0011 | 0.25 | 100 |
| 0.25 | 0.2409 | 1.5 | 0.0011 | 0.25 | 200 |
| 0.38 | 0.0823 | 1.5 | 0.0013 | 0.3 | 120 |
| 0.25 | 0.2891 | 1.5 | 0.0013 | 0.3 | 280 |

To assure that flow rate, pulse rate, and pressure readings were consistent with the values in which they were set, tolerated deviations were defined such that the system's parameters fell within a particular range: ±0.05 mL/min (flow), ±1 pulses/min (pulsatility), and ±0.5 mmHg (average pressure). Bulk total flow of the fluid cell suspension was measured over time by measuring the total fluid output (mL) after 10 min. Pump manufacturer pulsation rate specifications were confirmed by manually counting the number of times tubing was compressed over 1 min. Pressure was measured using a calibrated digital manometer zeroed at atmospheric pressure. Readings were then confirmed manually using a water column. A sample size of three was used in each verification test.

Musmusculus IC-21 macrophages derived from SV-40 transformed peritoneal macrophages with phagocytic properties were used primarily because of their mature phenotype and characteristic similarity to supraependymal macrophages found bound to central nervous system (CNS) implants.

Musmusculus IC-21 macrophages taken from a C57BL/6 mouse were obtained from ATCC (ATCC product number TIB-186). Macrophages were maintained in RPMI-1640 medium with 25 mM 4-(2-hydroxyethyl)-1-piperazineethanesulfonic acid (HEPES), 1% penicillin-streptomycin (Sigma, St. Louis, Mo.), 1% GlutaMAX (Sigma, St. Louis, Mo.), 1% sodium pyruvate (Invitrogen, Carlsbad, Calif.), and 10% fetal bovine serum (FBS, Sigma, St. Louis, Mo.). Cultures were split at 80% confluence.

Twenty-four hours before cell detachment for experimental analysis, cells were soaked in a low concentration of albumin-rich medium (0.5% FBS with 7.5 mg/mL Bovine Serum Albumin, SeraCare Life Sciences, Milford, Mass.). After several washing steps with noncationic Dulbecco's Phosphate-Buffered Saline (DPBS, Invitrogen), cultures were exposed to 1× TrypLE Express (Invitrogen) to initiate resuspension. After a 5-min incubation period, cells were removed. To facilitate macrophage removal, flasks were knocked sharply to mechanically dissociate cells from flasks. Subsequently, cells were added to medium that was centrifuged at 275×g for 10 min before cells were suspended in fresh medium.

A primary cortical astrocyte cell line from Rattusnorvegicus (Sprague Dawley strain) extracted at embryonic day 20 was chosen for this study because of its cell uniformity.

Astrocytes were separated from other cell types within cortical tissue using a shake-off procedure. Immediately after the dam had been euthanized with carbon dioxide, rat fetuses were extracted for astrocyte cultures at day 20 of gestation. The meninges of the embryos were removed, and brain tissue was minced and suspended in PBS containing 1 mg/mL DNase with manganese and 1× Trypsin. After a 10-min centrifugation at 275×g, the sample was resuspended, sieved through an 80-μm nylon mesh, and washed with Hank's Balanced Salt Solution (HBSS). The suspension was seeded and allowed to reach confluency. A shake-off procedure separated adherent astrocytes from other cell types; flow cytometry confirmed the presence of high glial fibrillary acidic protein (GFAP) in the dissociated cells. Rat astrocytes were cultured in RPMI-1640 with 25 mM HEPES, 1% penicillin-streptomycin, 1% GlutaMAX, and 10% FBS. Cultures were split at 80% confluence. Similarly to macrophage detachment, astrocytes used for experimental analysis were removed from culture flasks after a 24-hour exposure to the low protein medium using 1× TrypLE Express.

To confirm that our cultures of IC-21 mouse macrophages and primary rat astrocytes expressed antigens specific to their respective cell types, cells in culture plates were immunohistochemically stained with 1:500 polyclonal rabbit anti-ionized calcium binding adapter molecule 1 (Iba-1, Wako) and 1:500 polyclonal rabbit anti-GFAP (DakoCytomation, Glostrup, Denmark), respectively. Cells were treated with secondary goat anti-rabbit IgGbiotinylated antibody (1:200, Vector Laboratories, Burlingame, Calif.) for 45 min at room temperature. Avidin-biotin complex (ABC kit, Vector Laboratories) was added to the culture dishes for protein detection for 30 min and washed with 0.1 M PBS before samples were developed with diaminobenzidine (DAB Kit, Vector Laboratories). Astrocytes were also stained with Toluidine blue to stain the cell nuclei. Both cultures were analyzed using an inverted microscope (Carl Zeiss, Germany).

A concentration of approximately 3.00×10⁶/65 mL astrocytes or macrophages (46,000 cells/mL) was chosen for these experiments for two reasons: (1) astrocyte adhesion assays on silicone have used this cell concentration with conclusive results; (2) preliminary data from animals with hydrocephalus show nuclear positive cells (some with macrophage and astrocyte positive staining) in the CSF averaging approximately 41,000 cells/mL. This estimate was used to support the cell concentration from the previously noted study.

After one cycle (time for all cells to be exposed to the components once) and again three days after exposure (to determine longer-term effects on viability), the total cell count and viability with respect to each system component were analyzed using the Trypan blue exclusion assay. Each group had a minimum sample size of three.

The effect on cell viability attributable to the compressive forces of the pump was tested using two groups: (1) flow facilitated by positive air pressure in a closed system with no pump contact, and (2) flow enabled by positive air pressure and exposure to the pump. The former group compressed tubing that did not contain the cell solution whereas the latter compressed tubing that housed the cell solution.

The effect on cell viability attributable to protein concentration was tested by comparing viability after exposure to cell culture medium with 10% FBS, medium with 0.5% FBS and an albumin additive, and human CSF (a collection of CSF from 18 patients).

The effect on cell viability attributable to the suspension flask was tested by comparing viability with and without exposure.

The effect on viability due to a decrease in tubing diameter (used to gate flow) was tested using either PDMS or Marprene tubing at the pump site. A known caveat of this approach is that, although the flow rates (and therefore shear) were fixed and equal using both tubing types, the pulsation rate varied from 7 to 100 pulses/min.

The effect on cell viability attributable to the type of transport tubing was tested by comparing viability after exposure to PDMS, PDMS tubing with the addition of surface hydroxyl groups (OH-PDMS), and polystyrene-coated PDMS tubing (PS-OH-PDMS). OH-PDMS was obtained by placing tubing into an oxygen plasma chamber under a pressure of 200 mTorr and a power of 50 W for 2 min. The polystyrene (STYRON® 666D) modification was performed on a subset of OH-PDMS samples by injecting 15% (w/v) polystyrene in toluene into the tubing lumen, distributing the solution using compressed air, and drying the samples overnight at 70° C. to remove residual solvent.

To determine the effects of reusing the flow system on cell viability (since reincubating the system with cells could potentially enhance the longevity of each experiment), eight 15-μL aliquots of the cell suspension were analyzed at incremental time periods using the Trypan blue exclusion assay after initial exposure. Following the time period in which the total cell count was exhausted from the fluid suspension (see Results, approximately 20 hours), the system was resupplied with a second identical concentration. Finally, the system was resupplied 24 hours later for a total three-day incubation period. Cell viability data were graphed as the number of viable and dead cells over time and analyzed by integrating the area below the line of best fit for each curve. The number of cells at the beginning and end of each exposure period was also analyzed for significance using statistical methods outlined below.

To determine whether and to what degree cell adhesion had changed because of the additional incubation periods, samples were removed at the end of the three incubations and fixed with 4% (w/v) paraformaldehyde. Samples were cut longitudinally and fluorescently stained for analysis.

Catheter tubing was inserted at the sample site and exposed to either the macrophage or astrocyte solution. Samples were removed from the system, cut longitudinally to expose the tubing lumen, and washed with 1× binding buffer. Samples and any adherent cells were then fluorescently stained with 1:20 FITC-Annexin V in buffer containing 0.1% bovine serum albumin and 0.1% NaN₃, 1:20 0.8 μM/μL ethidiumhomodimer III in PBS, and 1:20 500 μg/ml Hoechst 33342 in PBS to stain for apoptotic, necrotic, and healthy cells, respectively, as detailed in the PromoKine Apoptotic/Necrotic/Healthy Cell Detection Kit (PromoKine, Heidelberg, Germany). After a 15-min incubation period at room temperature in the dark, samples were analyzed using an inverted fluorescent microscope (Carl Zeiss, Germany).

To find an appropriate technique to measure macrophage and astrocyte attachment after exposure to the flow system, fluorescent staining was attempted on longitudinally cut PDMS sample tubing after fixation with 4% (w/v) paraformaldehyde using actin, vinculin, and 4′,6-diamidino-2-phenylindole (DAPI) to stain macrophages and GFAP and DAPI to stain astrocytes. A double staining technique of actin and vinculin was chosen to identify macrophage cytoskeletal structure and focal contacts on the catheter surface to obtain a detailed perspective of macrophage morphology and attachment. Samples were exposed to a 1:300 concentration of polyclonal sheep anti-actin (Chemicon, Temecular, Calif.) in 0.1 M PBS followed by a 1:100 concentration of polyclonal donkey anti-sheep IgG with a cyanine 3 (Cy3) conjugate in 0.1 M PBS labeled actin filaments. A mouse monoclonal anti-vinculin primary antibody (Chemicon) was then used at a 1:300 concentration identified with a 1:100 concentration of fluorescein isothiocyanate (FITC)-labeled polyclonal goat anti-mouse immunoglobulin G (IgG) with heavy and light (H+L) chains (Chemicon). GFAP was chosen to label astrocytes because of its repetitive appearance in astrocyte literature and its ability to portray astrocyte morphology (GFAP has been shown to partially control the shape and movement of the astrocyte). A 1:300 concentration of monoclonal mouse anti-GFAP (Chemicon) in 0.1 M PBS was labeled using a 1:100 polyclonal goat anti-mouse IgG-FITC conjugated secondary antibody (Chemicon). Unless otherwise stated, all samples were incubated for 1 hour in the respective antibodies at 37° C. All samples were counterstained to identify the cell nuclei using DAPI diluted from 1 mg/mL stock to 1:1000 in 0.1 M PBS for 12 min at room temperature. Confocal imaging was performed using a Zeiss 510 microscope, and spectral epifluorescent images were obtained using a Nikon fluorescent CR1 Nuance microscope system. Images were observed using the Zeiss LSM image browser.

Three methods to analyze samples were attempted. First, images were analyzed for the total DAPI surface area with respect to the total sample surface area. This was done by hand-selecting the areas with software aid (Stereo Investigator, MicroBrightField, Williston, Vt.). A second method involved analysis of the average percentage of blue in digital Red-Green-Blue (dRGB) space using the DAPI intensity of the images. Lastly, adhesion was analyzed by removing cells, cellular debris, and extracellular matrix (ECM) from the PDMS sample tubing and concentrating the cell mixture on a microscope slide using a Shandon Cytospin 3 Cytocentrifuge (Fisher Scientific, Hampton, N.H.). The quantity of cellular particulate on the slide was then quantified using pixel luminance photometry (Neurolucida, Microbrightfield). A sample size of 12 was used for each analysis technique.

To determine the relevance of our model (testing luminal adhesion) to models where adhesion is measured on commercially available ventricular catheters, we measured macrophage and astrocyte adhesion on: (1) the lumen of PDMS tubing with a 1.5-mm inner diameter and 3.0-mm outer diameter (inner and outer diameters which fall in the range of many clinical shunt catheter dimensions); (2) on the interior surface (the lumen) of commercially available ventricular catheters; (3) on the exterior surface of commercially available ventricular catheters. Adhesion on the lumen of PDMS tubing (with inner diameter 1.5 mm) was also compared to adhesion on the lumen of PDMS with an inner diameter of 500 μm (the approximate diameter of the holes in clinical catheters). While the latter comparison maintained laminar flow through the tubing lumen, the dramatic variation in luminal diameter permitted a comparison of calculated shear stress.

The Anderson-Darling normality test was used if groups were normally distributed and the Bartlett's test was used to examine the degree of homoscedasticity across data sets. Parametric data were compared using either a two-tailed Student's t-test or a one-way analysis of variance (ANOVA). Nonparametric results were compared using the Mann-Whitney U Test and the Kruskal-Wallis H Test with a confidence interval of 0.95 (α=0.05). If the null hypothesis was rejected using a Kruskal-Wallis H Test, an unplanned comparison of mean ranks test was applied using least significance in difference rank.

Verification measurements were performed to confirm that flow rate, pulsation rate, and intraluminal pressure fell within tolerated deviances. The data revealed that flow (±0.018 mL/min), pulsation rate (±1 compression/min), and intraluminal pressure (±0.24 mmHg) all fell within the tolerated deviances of ±0.05 mL/min, ±1 pulses/min, and ±0.5 mmHg, respectively.

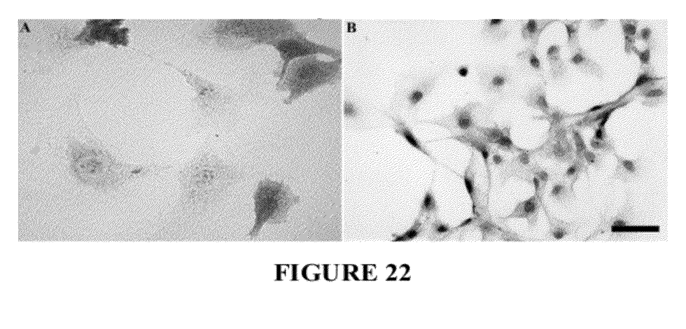

Macrophages were stained positively with Iba-1 and astrocytes were stained positively with GFAP (FIG. 22). Adherent to the culture flask and without exposure to flow, both cell types exhibit extended processes.

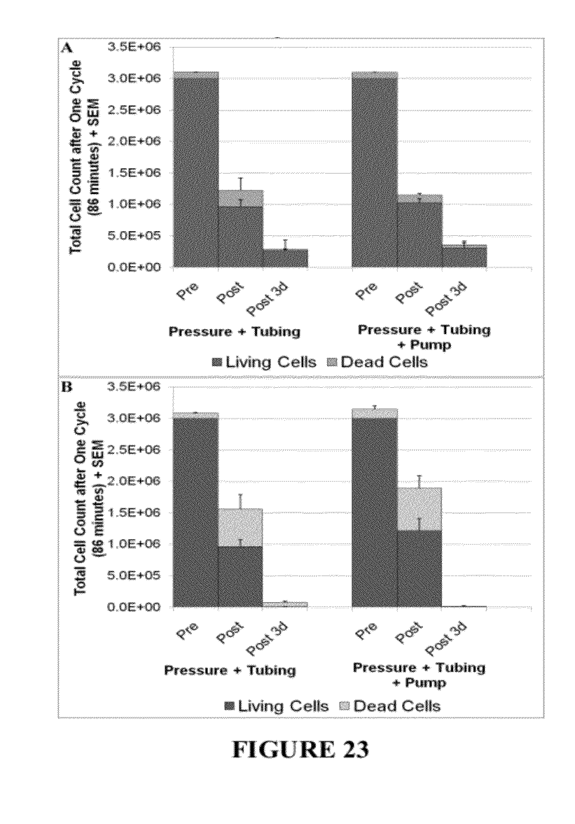

The compressive forces of the pump did not cause a significant decline in cell viability, although macrophage and astrocyte viability decreased significantly immediately after exposure (P<0.01) and 3 days after exposure (P<0.01) to either system setup (FIG. 23).

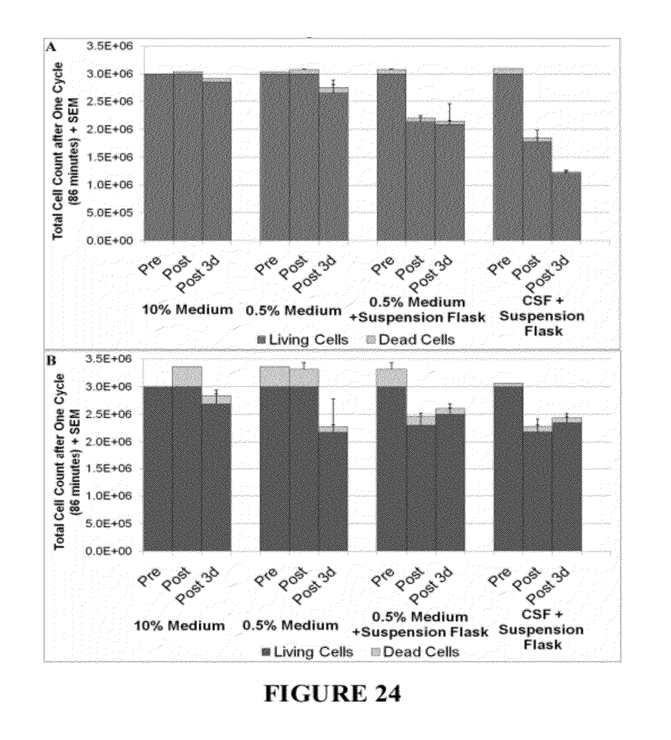

Protein concentration did not cause a significant decay in macrophage or astrocyte viability except when CSF was used rather than medium (FIG. 24), P<0.01 when comparing pre and post conditions). When comparing cell viability before, immediately after, and 3 days after incubation across groups, there was a significant difference in the number of living macrophages caused by the addition of the suspension flask (P<0.01) but by changes in the protein content (P=0.18). When astrocyte viability was examined, exposure to CSF under flow conditions caused a significant decrease in cell viability compared with static cultures using 10% (P<0.05) and 0.5% (P<0.05) serum, but there was no significant difference in viability when comparing 0.5% serum with the albumin additive and CSF when cells were held in suspension with the suspension flask (P=0.95).

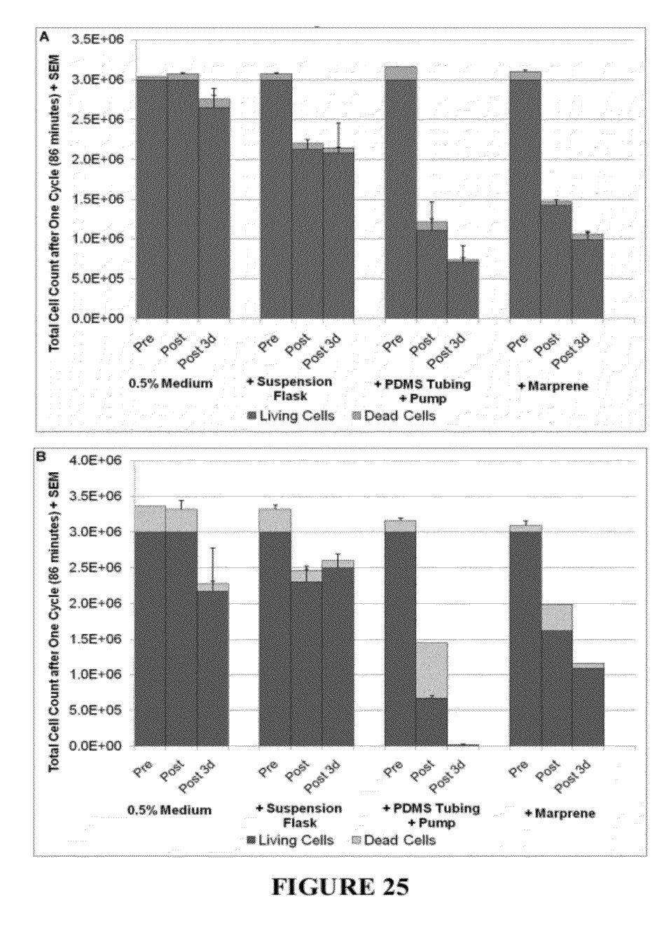

FIG. 25 illustrates that contact with the suspension flask caused a significant decline in the number of viable macrophages but not viable astrocytes. PDMS tubing and Marprene tubing (in combination with flow) both caused the number of viable macrophages and astrocytes to decrease significantly (P<0.05), but the difference in viability between these two tubing types was not significant.

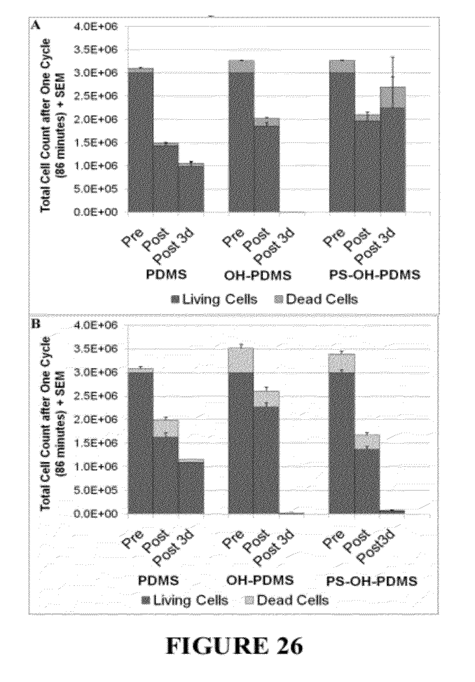

Compared with cell viability before contact, contact with PDMS and oxidized PDMS (OH-PDMS) each caused a significant decrease in viable macrophages (P<0.01); PDMS (P<0.05), OH-PDMS (P<0.01), and polystyrene-coated PDMS (PS-OH-PDMS, P<0.01) each caused a significant decrease in viable astrocytes (FIG. 26). The difference in macrophage viability after exposure to PDMS, OH-PDMS, or PS-OH-PDMS was insignificant. Astrocyte viability was significantly greater when in contact with OH-PDMS than with PS-OH-PDMS (P<0.05). Three days after exposure to PDMS, the number of viable cells was greater than after exposure to OH-PDMS (P<0.01) or PS-OH-PDMS (P<0.01).

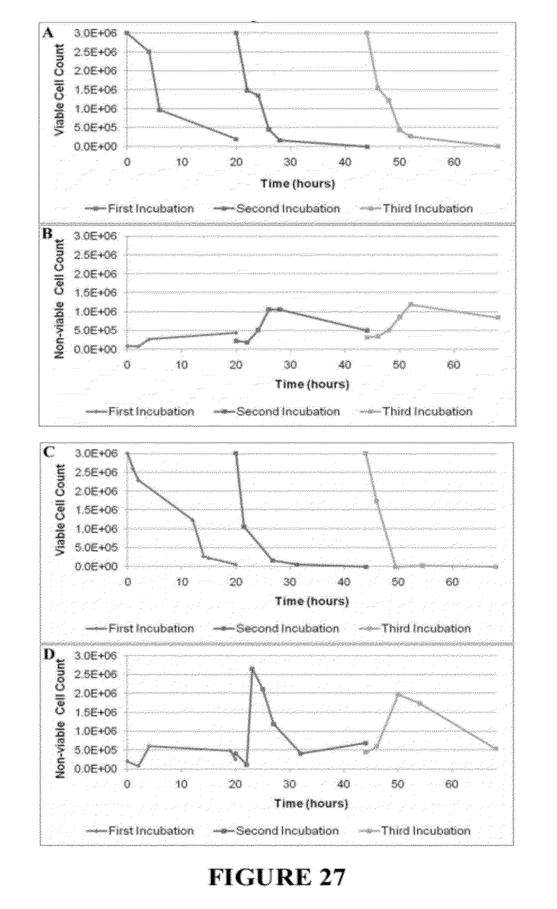

Based on the number of living cells in suspension, nearly 100% of 3.00×10⁶ macrophages and astrocytes either bound to catheter tubing or were converted into cellular debris after approximately 20 hours of exposure to the HSCB (FIG. 27). However, while the number of living macrophages and astrocytes in suspension decreased over time during the first 20 hours, the number of dead cells in suspension before exposure to the system (1411.25 macrophages/mL±219.63; 3148.90±867.03 astrocytes/mL) was not statistically different from the number of dead cells after the 20-hour exposure (6788.46±1630.95 macrophages/mL, P=0.06; 3910.26±1488.25 astrocytes/mL, P=0.77).

The number of living macrophages and astrocytes in suspension decreased over time (FIG. 27, Table 4); this phenomenon occurred at a quicker rate with each subsequent incubation such that the area under the curve for the first incubation was significantly greater (P<0.05) than for the second and third incubations. The number of dead macrophages in suspension increased significantly in the second (P<0.05) and third (P<0.01) macrophage incubation compared with the first incubation. The number of dead astrocytes in suspension was not significantly different throughout each incubation, although qualitative analysis suggested that the number of dead astrocytes in suspension in the second and third incubations appeared to increase over the first few hours and then gradually decrease.

TABLE 4

| | First Incubation | Second Incubation | Third Incubation |
|---|---|---|---|
| | (0-20 hours) | (20-44 hours) | (44-68 hours) |
| Astrocyte | 20,368,180 ± | 5,763,396 ± | 7,588,020 ± |
| | 6,985,370 | 937,508 | 1,059,452 |
| Macrophage | 20,074,310 ± | 10,790,979 ± | 12,106,250 ± |
| | 3,848,177 | 1,029,678 | 880,545 |

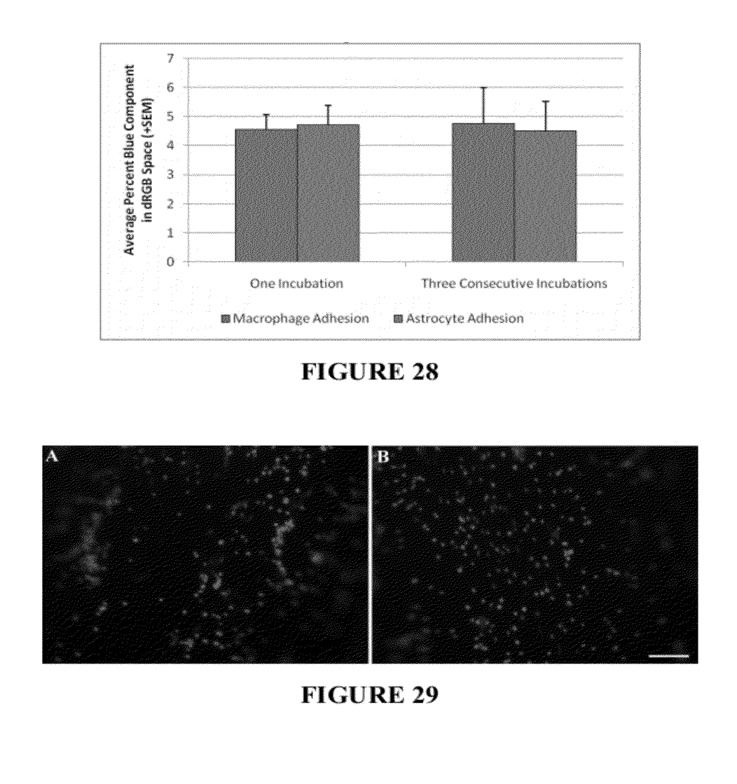

After analysis of viability of cells in solution, the degree of cell attachment was analyzed (FIG. 28). At the end of the three consecutive incubations, there was no significant difference in macrophage (P=0.17) or astrocyte (P=0.26) attachment compared with the degree of adhesion present after one incubation period.

As seen in FIG. 29, there is little to no evidence of apoptotic cells. A majority of the cells appear to be necrotic with a presence of some healthy cells.

Fluorescent staining and subsequent confocal imaging and cell removal were performed to determine an appropriate analysis technique. Each of the three techniques was completed and data were attained successfully (Table 5).

TABLE 5

| | DAPI Area | DAPI Intensity | Luminance of |
|---|---|---|---|
| | (Average Percent | (Average Percent Blue | Concentrated Debris |
| | Area Occupied) ± | Component in dRGB | (Pixel Luminance) ± |
| | SEM | Space) ± SEM | SEM |
| Macro- | 1.31 ± 0.33 | 4.55 ± 0.54 | 171.70 ± 0.36 |
| phage | | | |
| Astro- | 1.86 ± 0.26 | 4.71 ± 0.69 | 173.50 ± 2.61 |
| cyte | | | |

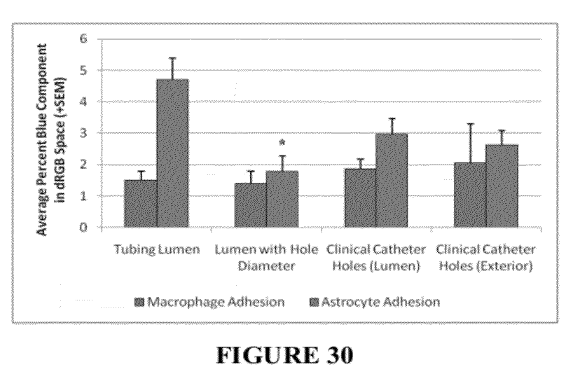

There was no statistically significant difference in macrophage adhesion on the wall of the tubing lumen, on the wall of tubing lumen with a diameter equal to the diameter of the holes, or around the holes of the clinical catheter analyzed from the perspective of the lumen or the catheter exterior (FIG. 30). Astrocyte adhesion results followed the same pattern: There were no statistically significant differences in groups except for a difference between adhesion on PDMS with the large (1.5-mm) and small (500-μm) inner diameters (P<0.05). Qualitative image analysis of the clinical catheters suggested that macrophages and astrocytes accumulated around the drainage holes but not on the hole walls.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

### Equivalents

Those skilled in the art will recognize, or be able to ascertain, using no more than routine experimentation, numerous equivalents to the specific embodiments described specifically herein. Such equivalents are intended to be encompassed in the scope of the following claims.

What is claimed is:

1. An in vitro pulsatile flow system comprising:
a medical implant having an inner surface defining a bore, the bore having an inlet and an outlet;
a fluid reservoir defining an inner chamber, the inner chamber configured to contain a desired fluid having at least one component, wherein the inner chamber of the fluid reservoir is in fluid communication with the outlet of the bore of the medical implant;
a pump in fluid communication with the inner chamber of the fluid reservoir and the inlet of the bore of the medical implant, wherein the pump is configured to direct flow of the desired fluid to the inlet of the bore of the medical implant at a desired rate such that at least a portion of the inner surface of the medical implant contacts the desired fluid; and
a first pressure valve positioned therebetween and in fluid communication with the outlet of the bore of the medical implant and the inner chamber of the fluid reservoir, wherein the first pressure valve is configured to modulate the flow of the desired fluid between the outlet of the bore of the medical implant and the inner chamber of the fluid reservoir,
wherein the at least one component of the desired fluid comprises at least one of cells, proteins, and tissue.

2. The in vitro pulsatile flow system of claim 1, wherein the desired fluid is configured to simulate cerebrospinal fluid, wherein the desired fluid comprises cells, and wherein the concentration of cells within the desired fluid ranges from about 40,000 cells per milliliter to about 50,000 cells per milliliter.

3. The in vitro pulsatile flow system of claim 1, wherein the medical implant comprises a catheter.

4. The in vitro pulsatile flow system of claim 1, further comprising a pressure sensor positioned therebetween and in fluid communication with the pump and the inlet of the bore of the medical implant, wherein the pressure sensor is configured to measure the fluid pressure of the desired fluid therebetween the pump and the inlet of the bore of the medical implant.

5. The in vitro pulsatile flow system of claim 1, further comprising means for modulating flow of the desired fluid therebetween the inner chamber of the fluid reservoir and the pump.

6. The in vitro pulsatile flow system of claim 5, wherein the inner chamber of the fluid reservoir is positioned in fluid communication with the pump through a tubing assembly, and wherein the means for modulating flow of the desired fluid therebetween the inner chamber of the fluid reservoir and the pump comprises a reduced-diameter tubing section having a diameter that is less than the diameter of each respective adjoining tube within the tubing assembly, wherein the diameter of the reduced-diameter tubing section ranges from about 0.25 mm to about 0.50 mm.

7. The in vitro pulsatile flow system of claim 1, wherein the at least one component of the desired fluid comprises proteins, and wherein the concentration of proteins within the desired fluid ranges from about 20 milligrams per deciliter to about 40 milligrams per deciliter.

8. The in vitro pulsatile flow system of claim 1, wherein the at least one component of the desired fluid comprises tissue, and wherein the tissue within the desired fluid comprises choroid plexus tissue.

9. An in vitro pulsatile flow system comprising:
a test material;
a test material housing, the test material housing having an inlet and an outlet, wherein the test material is removably secured within the test material housing;
a fluid reservoir defining an inner chamber, the inner chamber configured to contain a desired fluid having at least one component, wherein the inner chamber of the fluid reservoir is in fluid communication with the outlet of the test material housing;
a pump in fluid communication with the inner chamber of the fluid reservoir and the inlet of the test material housing, wherein the pump is configured to direct flow of the desired fluid to the inlet of the test material housing at a desired rate such that at least a portion of the test material contacts the desired fluid; and
a first pressure valve positioned therebetween and in fluid communication with the outlet of the test material housing and the inner chamber of the fluid reservoir, wherein the first pressure valve is configured to modulate the flow of the desired fluid between the outlet of test material housing and the inner chamber of the fluid reservoir,
wherein the at least one component of the desired fluid comprises at least one of cells, proteins, and tissue.

10. The in vitro pulsatile flow system of claim 9, wherein the desired fluid is configured to simulate cerebrospinal fluid, wherein the desired fluid comprises cells, and wherein the concentration of cells within the desired fluid ranges from about 40,000 cells per milliliter to about 50,000 cells per milliliter.

11. The in vitro pulsatile flow system of claim 9, wherein the test material comprises at least a portion of a medical implant.

12. The in vitro pulsatile flow system of claim 11, wherein the test material comprises at least a portion of a catheter.

13. The in vitro pulsatile flow system of claim 12, wherein the test material comprises a ventricular catheter tip.

14. The in vitro pulsatile flow system of claim 9, further comprising means for modulating flow of the desired fluid therebetween the inner chamber of the fluid reservoir and the pump.

15. The in vitro pulsatile flow system of claim 14, wherein the inner chamber of the fluid reservoir is positioned in fluid communication with the pump through a tubing assembly, and wherein the means for modulating flow of the desired fluid therebetween the inner chamber of the fluid reservoir and the pump comprises a reduced-diameter tubing section having a diameter that is less than the diameter of each respective adjoining tube within the tubing assembly, wherein the diameter of the reduced-diameter tubing section ranges from about 0.25 mm to about 0.50 mm.

16. The in vitro pulsatile flow system of claim 9, wherein the at least one component of the desired fluid comprises proteins, and wherein the concentration of proteins within the desired fluid ranges from about 20 milligrams per deciliter to about 40 milligrams per deciliter.

17. The in vitro pulsatile flow system of claim 9, wherein the at least one component of the desired fluid comprises tissue, and wherein the tissue within the desired fluid comprises choroid plexus tissue.

18. The in vitro pulsatile flow system of claim 9, further comprising a tissue construct positioned in contact with at least a portion of the test material within the test material housing.

19. The in vitro pulsatile flow system of claim 9, wherein the outlet of the housing is configured to removably receive the test material.

20. The in vitro pulsatile flow system of claim 11, wherein an inner surface of the medical implant defines a bore, the bore having at least one inlet and at least one outlet, each inlet of the bore being configured to receive the desired fluid, and wherein the outlet of the test material housing is configured to removably receive the at least one outlet of the bore of the medical implant such that the at least one inlet of the bore of the medical implant is positioned within the test material housing.

21. A method of screening for a medical implant that reduces or inhibits adhesion of at least one component of a desired fluid to the medical implant, comprising the steps of:
providing a fluid reservoir, the fluid reservoir defining an inner chamber;
positioning a desired fluid within the inner chamber of the fluid reservoir;
establishing fluid communication between the inner chamber of the fluid reservoir and a pump;
providing a test medical implant, the test medical implant having an inner surface defining a bore, the bore of the test medical implant having at least one inlet and at least one outlet;
establishing fluid communication between the pump and the at least one inlet of the bore of the test medical implant;
establishing fluid communication between the at least one outlet of the bore of the test medical implant and the inner chamber of the fluid reservoir;
activating the pump such that the pump directs flow of the desired fluid to the at least one inlet of the test medical implant and the desired fluid contacts at least a portion of the test medical implant; and
determining inhibition of adhesion of at least one component of the desired fluid to the test medical implant, wherein inhibition of adhesion of the at least one component to the test medical implant indicates that the test medical implant reduces or inhibits adhesion of the at least one component to the test medical implant,
wherein the at least one component of the desired fluid comprises at least one of cells, protein, and tissue.

22. The method of claim 21, wherein the steps of establishing fluid communication between the pump and the at least one inlet of the test medical implant and between the at least one outlet of the test medical implant and the inner chamber of the fluid reservoir comprise securing the test medical implant within a test material housing having an inlet and an outlet, positioning the inlet of the test material housing in fluid communication with the pump, and positioning the outlet of the test material housing in fluid communication with the inner chamber of the fluid reservoir.

23. The method of claim 21, wherein the desired fluid is configured to simulate cerebrospinal fluid, wherein the desired fluid comprises cells, and wherein the concentration of cells within the desired fluid ranges from about 40,000 cells per milliliter to about 50,000 cells per milliliter.

24. The method of claim 21, wherein the at least one component of the desired fluid comprises proteins, and wherein the concentration of proteins within the desired fluid ranges from about 20 milligrams per deciliter to about 40 milligrams per deciliter.

25. The method of claim 21, wherein the at least one component of the desired fluid comprises tissue, and wherein the tissue within the desired fluid comprises choroid plexus tissue.

26. The method of claim 22, further comprising the step of positioning a tissue construct in contact with at least a portion of the test medical implant within the test material housing.

27. The method of claim 21, wherein the desired fluid further comprises a test composition, and wherein inhibition of adhesion of the at least one component to the medical implant further indicates that the test composition reduces or inhibits adhesion of the at least one component to the medical implant.
